(19) United States
(12) Patent Application Publication
(10) Pub. No.: US 2024/0158675 A1
(43) Pub. Date: May 16, 2024

(54) ADHESIVE SHEET AND METHOD FOR MANUFACTURING STRUCTURE

(71) Applicant: LINTEC CORPORATION, Tokyo (JP)

(72) Inventors: Sho KOSABA, Tokyo (JP); Yoichi TAKAHASHI, Tokyo (JP)

(73) Assignee: LINTEC CORPORATION, Tokyo (JP)

(21) Appl. No.: 18/283,645

(22) PCT Filed: Oct. 25, 2021
(86) PCT No.: PCT/JP2021/039341

§ 371 Date: Sep. 22, 2023

(30) Foreign Application Priority Data
Mar. 24, 2021 (JP) 2021-050686

(51) Int. Cl. C09J 7/38; B32B 7/023; B32B 7/06; B32B 7/12; B32B 27/08; B32B 27/30; B32B 37/12; C09D 133/08; C09J 5/00

(52) U.S. Cl. CPC C09J 7/385; B32B 7/023; B32B 7/06; B32B 7/12; B32B 27/08; B32B 27/308; B32B 37/12; C09D 133/08; C09J 5/00; B32B 2307/4026; B32B 2307/412; B32B 2307/414; B32B 2307/54; B32B 2307/748; C09J 2301/208; C09J 2301/302; C09J 2301/408; C09J 2433/00

(57) ABSTRACT

A pressure sensitive adhesive sheet for bonding two rigid plates together, at least one of the two rigid plates having irregularities on a surface on a side to be bonded to the other rigid plate, the pressure sensitive adhesive sheet containing: a composite pressure sensitive adhesive layer containing an optically functional pressure sensitive adhesive layer and a transparent pressure sensitive adhesive layer that does not have an optical function of the optically functional pressure sensitive adhesive layer; and a release sheet laminated on the transparent pressure sensitive adhesive layer in the composite pressure sensitive adhesive layer, the composite pressure sensitive adhesive layer having a straightforward transmittance of 90% or less for light rays having a wavelength of 550 nm. According to such a pressure sensitive adhesive sheet, uneven optical function in the pressure sensitive adhesive layers can be suppressed.

### TECHNICAL FIELD

The present invention relates to a pressure sensitive adhesive sheet for bonding two rigid plates together and relates also to a method for manufacturing a structure using the pressure sensitive adhesive sheet.

### BACKGROUND ART

Image display devices such as liquid crystal display devices and organic electroluminescence devices are increasingly used in modern display bodies (displays), for example, display bodies for in-vehicle use such as those of various meters provided on instrument panels, car navigation systems, and consoles of automobiles, display bodies such as those of smartphones and tablet terminals for general users, display bodies such as those of tablet terminals and digital signage for commercial use, display bodies such as those of outdoor digital signage, etc.

In the display bodies including those for in-vehicle use as described above, it may be required to improve the design properties of a display body by achieving a sense of unity with a peripheral member of the display body, for example, a frame material, when the display body is turned off. To this end, it is conceivable to color the display body. As an example, Patent Document 1 discloses an invention of providing, as a part of layers constituting the display body, a colored layer in which a colorant is dispersed and contained in a pressure sensitive adhesive.

### PRIOR ART DOCUMENTS

### Patent Documents

[Patent Document 1] JP2012-234028A

### SUMMARY OF THE INVENTION

### Problems to be Solved by the Invention

In the invention described in Patent Document 1, the colored layer is provided so as to be in contact with a concealing layer formed in the shape of a frame in a plan view of the display body, that is, in contact with steps. In a display body having such a configuration, however, uneven transmittance occurs in the colored layer. Also in a light-diffusing pressure sensitive adhesive layer containing, for example, light-diffusing fine particles rather than a colorant, when the layer is provided so as to be in contact with steps as described above, uneven light diffusion occurs in the layer. Such uneven transmittance or uneven light diffusion may cause a problem of uneven brightness in the obtained display body.

The present invention has been made in view of such actual circumstances as described above, and objects of the present invention include providing a pressure sensitive adhesive sheet and a method for manufacturing a structure that are able to suppress uneven optical function in a pressure sensitive adhesive layer.

### Means for Solving the Problems

To achieve the above objects, first, the present invention provides a pressure sensitive adhesive sheet for bonding two rigid plates together, at least one of the two rigid plates having irregularities on a surface on a side to be bonded to the other rigid plate, the pressure sensitive adhesive sheet comprising: a composite pressure sensitive adhesive layer comprising an optically functional pressure sensitive adhesive layer and a transparent pressure sensitive adhesive layer that does not have an optical function of the optically functional pressure sensitive adhesive layer; and a release sheet laminated on the transparent pressure sensitive adhesive layer in the composite pressure sensitive adhesive layer, the composite pressure sensitive adhesive layer having a straightforward transmittance of 90% or less for light rays having a wavelength of 550 nm (Invention 1). This pressure sensitive adhesive sheet may be preferably used so that the optically functional pressure sensitive adhesive layer is bonded to either one of the above two rigid plates prior to the transparent pressure sensitive adhesive layer.

The pressure sensitive adhesive sheet according to the above invention (Invention 1) has the above configuration and may be used as above, and it is thereby possible to suppress uneven optical function in the pressure sensitive adhesive layer.

In the above invention (Invention 1), when the optical function of the optically functional pressure sensitive adhesive layer is coloring, the composite pressure sensitive adhesive layer may preferably have a haze value of 0.1% or more and 30% or less (Invention 2).

In the above invention (Invention 1), when the optical function of the optically functional pressure sensitive adhesive layer is light diffusion, the composite pressure sensitive adhesive layer may preferably have a haze value of 70% or more and 100% or less (Invention 3).

In the above invention (Invention 1, 2), when the optical function of the optically functional pressure sensitive adhesive layer is coloring, the composite pressure sensitive adhesive layer may preferably have a total luminous transmittance of 5% or more and 90% or less (Invention 4).

In the above invention (Invention 1, 3), when the optical function of the optically functional pressure sensitive adhesive layer is light diffusion, the composite pressure sensitive adhesive layer may be preferably a total luminous transmittance of 70% or more and 100% or less (Invention 5).

In the above invention (Invention 1 to 5), a pressure sensitive adhesive that constitutes the optically functional pressure sensitive adhesive layer may be preferably an acrylic-based pressure sensitive adhesive (Invention 6).

In the above invention (Invention 1 to 6), a pressure sensitive adhesive that constitutes the transparent pressure sensitive adhesive layer may be preferably an acrylic-based pressure sensitive adhesive (Invention 7).

In the above invention (Invention 1 to 7), the release sheet laminated on the transparent pressure sensitive adhesive layer in the composite pressure sensitive adhesive layer may be preferably a tight release sheet, and an easy release sheet may be preferably laminated on the optically functional pressure sensitive adhesive layer in the composite pressure sensitive adhesive layer (Invention 8).

Second, the present invention provides a method for manufacturing a structure obtained by bonding two rigid plates together, at least one of the two rigid plates having irregularities on a surface on a side to be bonded to the other rigid plate, the method comprising: bonding an optically functional pressure sensitive adhesive layer of a composite pressure sensitive adhesive layer to one of the two rigid plates, the composite pressure sensitive adhesive layer comprising the optically functional pressure sensitive adhesive layer and a transparent pressure sensitive adhesive layer that does not have an optical function of the optically functional pressure sensitive adhesive layer, the composite pressure sensitive adhesive layer having a straightforward transmittance of 90% or less for light rays having a wavelength of 550 nm; and then bonding the transparent pressure sensitive adhesive layer of the composite pressure sensitive adhesive layer and the other of the two rigid plates (Invention 9). The above composite pressure sensitive adhesive layer may have the configuration of the above invention (Invention 2 to 7).

In the above invention (Invention 9), both the two rigid plates may be preferably display body structural members (Invention 10).

### Advantageous Effect of the Invention

The pressure sensitive adhesive sheet and method for manufacturing a structure according to the present invention can suppress uneven optical function in the pressure sensitive adhesive layers.

### BRIEF DESCRIPTION OF DRAWINGS

FIG. 1 is a cross-sectional view of a pressure sensitive adhesive sheet according to an embodiment of the present invention.

FIG. 2 is a cross-sectional view of a structure according to an embodiment of the present invention.

FIG. 3 is a cross-sectional view of a structure according to another embodiment of the present invention.

### EMBODIMENTS FOR CARRYING OUT THE INVENTION

Hereinafter, one or more embodiments of the present invention will be described.

### <Pressure Sensitive Adhesive Sheet>

The pressure sensitive adhesive sheet according to an embodiment of the present invention is a pressure sensitive adhesive sheet for bonding two rigid plates together, and at least one of the above two rigid plates has irregularities on the surface on the side to be bonded to the other rigid plate. The pressure sensitive adhesive sheet according to the present embodiment comprises: a composite pressure sensitive adhesive layer comprising an optically functional pressure sensitive adhesive layer and a transparent pressure sensitive adhesive layer; and a release sheet laminated on the transparent pressure sensitive adhesive. The optically functional pressure sensitive adhesive layer has a predetermined optical function while the transparent pressure sensitive adhesive layer does not have the optical function of the above optically functional pressure sensitive adhesive layer. The straightforward transmittance of light rays having a wavelength of 550 nm in the composite pressure sensitive adhesive layer is 90% or less. As used in the present specification, the straightforward transmittance refers to a transmittance calculated based on the total transmittance and diffuse transmittance of the total transmitted light components transmitted through a sample, and the details of a measurement method are as described in the Testing Example, which will be described later.

The optical function possessed by the above optically functional pressure sensitive adhesive layer may be an optical function that affects the straightforward transmittance of light rays having a wavelength of 550 nm, and examples thereof include coloring (absorption/reflection), light diffusion, light shielding, and light refraction.

The “release sheet” in the present embodiment refers to a flexible sheet that is removed from the pressure sensitive adhesive layer at any stage. It is therefore not limited to a general release sheet including a release agent layer, and a film including no release agent layer, a certain base material having flexibility, or the like corresponds to the release sheet, provided that it can be removed from the pressure sensitive adhesive layer.

Here, the pressure sensitive adhesive sheet according to the present embodiment may be preferably used so that the optically functional pressure sensitive adhesive layer is bonded to either one of the two rigid plates prior to the transparent pressure sensitive adhesive layer. The pressure sensitive adhesive sheet according to the present embodiment has the above configuration and may be used as above, and it is thereby possible to effectively suppress uneven optical function in the composite pressure sensitive adhesive layer. The rigid plate to which the optically functional pressure sensitive adhesive layer is bonded first may have or may not have irregularities on the surface on the side to be bonded to the other rigid plate.

When the optically functional pressure sensitive adhesive layer is bonded first to a first rigid plate as described above, the bonding can be performed using the force components from all angles (force in the vertical direction and force in the shear direction) while bending the pressure sensitive adhesive sheet (in general, bonding can be performed with equipment that is less likely to allow air bubbles to enter, such as using lamination rolls), and the composite pressure sensitive adhesive layer can be satisfactorily bonded without damaging the optically functional pressure sensitive adhesive layer regardless of whether the bonding surface of the first rigid plate has irregularities. Then, when the first rigid plate with the composite pressure sensitive adhesive layer and the second rigid plate are bonded together, both are members that do not bend, so the bonding is performed between flat surfaces mainly with the force in the vertical direction (in general, the bonding is performed by vacuum bonding, atmospheric pressure bonding, or the like), but stress is less likely to be applied because the optically functional pressure sensitive adhesive layer is already bonded to the first rigid plate. On the other hand, while the transparent pressure sensitive adhesive layer is liable to be stressed, the transparent pressure sensitive adhesive layer absorbs the deformation and is less likely to affect the optically functional pressure sensitive adhesive layer. Moreover, even when the bonding surface of the second rigid plate has irregularities, the transparent pressure sensitive adhesive layer can readily absorb the deformation caused by the irregularities. Note that uneven optical function does not occur in the transparent pressure sensitive adhesive layer itself. Therefore uneven optical function is less likely to occur in the transparent pressure sensitive adhesive layer and accordingly in the composite pressure sensitive adhesive layer regardless of whether the bonding surface of the second rigid plate has irregularities. On the other hand, if the above order is reversed so that the transparent pressure sensitive adhesive layer is bonded first to the first rigid plate and then the optically functional pressure sensitive adhesive layer is bonded to the second rigid plate, stress is liable to be applied when the optically functional pressure sensitive adhesive layer is bonded to the second rigid plate, and deformation or distortion is likely to occur, resulting in uneven optical function (regardless of whether the bonding surface of the second rigid plate has irregularities).

For example, when the optical function is coloring, if the transparent pressure sensitive adhesive layer is bonded to one rigid plate prior to the optically functional pressure sensitive adhesive layer and then the optically functional pressure sensitive adhesive layer and the other rigid plate are bonded together, the color of the optically functional pressure sensitive adhesive layer becomes light and dark due to the irregularities of the rigid plate, causing the occurrence of uneven transmittance. Fortunately, however, when the optically functional pressure sensitive adhesive layer is bonded to one rigid plate prior to the transparent pressure sensitive adhesive layer as described above and the transparent pressure sensitive adhesive layer and the other rigid plate are then bonded together, the color of the optically functional pressure sensitive adhesive layer does not become light and dark, and the occurrence of uneven transmittance is suppressed.

When the optical function is light diffusion, for example, if the transparent pressure sensitive adhesive layer is bonded to one rigid plate prior to the optically functional pressure sensitive adhesive layer and then the optically functional pressure sensitive adhesive layer and the other rigid plate are bonded together, uneven light diffusion occurs in the optically functional pressure sensitive adhesive layer due to the irregularities of the rigid plate. Fortunately, however, when the optically functional pressure sensitive adhesive layer is bonded to one rigid plate prior to the transparent pressure sensitive adhesive layer as described above and the transparent pressure sensitive adhesive layer and the other rigid plate are then bonded together, the uneven light diffusion does not occur in the optically functional pressure sensitive adhesive layer, and the uniformity of light diffusion can be maintained.

The above two rigid plates may be preferably display body structural members. The rigid plates, the display body, and the display body structural members will be described later. In a display body obtained by using the pressure sensitive adhesive layers of the pressure sensitive adhesive sheet according to the present embodiment, unevenness in optical functions such as transmittance and light diffusion in the pressure sensitive adhesive layers is suppressed, and the occurrence of a problem such as uneven brightness in the display body can thereby be suppressed. Note, however, that the pressure sensitive adhesive sheet according to the present embodiment is not limited to use for a display body.

As described above, the straightforward transmittance of light rays having a wavelength of 550 nm in the composite pressure sensitive adhesive layer is preferably 90% or less and may be more preferably 80% or less, particularly preferably 65% or less, and further preferably 50% or less. This allows the optically functional pressure sensitive adhesive layer to well exhibit the optical function. For example, when the optical function is coloring, a desired degree of coloring can be readily obtained. As an example, it is easy to give a display body a sense of unity with a peripheral member (e.g., a frame member), and the display body has excellent concealability. As used in the present specification, the term “concealability” means that when a display body is turned off, the appearance of a display unit of the display and the appearance of peripheral members and the like such as a frame-like printed layer and a frame material are in harmony and the boundaries between them get difficult to see. When the optical function is light diffusion, for example, a desired degree of light diffusion can be readily obtained, and uneven brightness can be satisfactorily prevented accordingly.

On the other hand, considering the visibility of the display body, the lower limit of the above straightforward transmittance may be preferably 5% or more, more preferably 18% or more, particularly preferably 28% or more, and further preferably 38% or more.

The straightforward transmittance of light rays having a wavelength of 550 nm in the optically functional pressure sensitive adhesive layer may be preferably 90% or less, more preferably 80% or less, particularly preferably 65% or less, and further preferably 50% or less. This allows the straightforward transmittance of light rays having a wavelength of 550 nm in the composite pressure sensitive adhesive layer to readily satisfy the above value. Moreover, the optical function of the optically functional pressure sensitive adhesive layer can be satisfactorily exhibited. Considering the visibility of the display body, the lower limit of the above straightforward transmittance may be preferably 10% or more, more preferably 20% or more, particularly preferably 30% or more, and further preferably 38% or more.

The straightforward transmittance of light rays having a wavelength of 550 nm in the transparent pressure sensitive adhesive layer may be preferably 90% or more, more preferably 95% or more, particularly preferably 98% or more, and further preferably 99% or more. Preferably. This allows the transparency of the transparent pressure sensitive adhesive layer to be maintained and also allows the visibility of the display body to be satisfactory. The upper limit of the above straightforward transmittance is not particularly limited, but may be preferably 100% or less, particularly preferably 99.8% or less, and further preferably 99.5% or less.

When the optical function of the optically functional pressure sensitive adhesive layer is coloring, the haze value (value measured according to JIS K7136: 2000; here and hereinafter) of the composite pressure sensitive adhesive layer may be preferably 30% or less, more preferably 20% or less, particularly preferably 10% or less, and further preferably 5% or less. This allows the visibility of the display body to be satisfactory. From another aspect, the haze value of the above composite pressure sensitive adhesive layer may be preferably 0.1% or more, more preferably 1% or more, particularly preferably 2% or more, and further preferably 4% or more. This allows the degree of coloring to be satisfactory.

When the optical function of the optically functional pressure sensitive adhesive layer is light diffusion, the haze value of the composite pressure sensitive adhesive layer may be preferably 70% or more, more preferably 80% or more, particularly preferably 85% or more, and further preferably 90% or more. This allows the light diffusion to be exhibited satisfactorily. On the other hand, considering the visibility of the display body, the upper limit of the haze value of the composite pressure sensitive adhesive layer may be preferably 100% or less, also preferably 98% or less, particularly preferably 95% or less, and further preferably 93% or less.

When the optical function of the optically functional pressure sensitive adhesive layer is coloring, the haze value of the optically functional pressure sensitive adhesive layer may be preferably 30% or less, also preferably 20% or less, particularly preferably 10% or less, and further preferably 5% or less. This allows the visibility of the display body to be satisfactory. From another aspect, the haze value of the above optically functional pressure sensitive adhesive layer may be preferably 0.1% or more, more preferably 0.5% or more, particularly preferably 1% or more, and further preferably 2% or more. This allows the degree of coloring to be satisfactory.

When the optical function of the optically functional pressure sensitive adhesive layer is light diffusion, the haze value of the optically functional pressure sensitive adhesive layer may be preferably 70% or more, more preferably 80% or more, particularly preferably 85% or more, and further preferably 90% or more. This allows the light diffusion to be readily and well exhibited. On the other hand, considering the visibility of the display body, the haze value of the above optically functional pressure sensitive adhesive layer may be preferably 100% or less, also preferably 98% or less, particularly preferably 95% or less, and further preferably 93% or less.

The haze value of the transparent pressure sensitive adhesive layer may be preferably 5% or less, more preferably 3% or less, particularly preferably 1% or less, and further preferably 0.5% or less. This allows the transparency of the transparent pressure sensitive adhesive layer to be maintained and also allows the visibility of the display body to be satisfactory. The lower limit of the haze value of the transparent pressure sensitive adhesive layer is not particularly limited, but may be preferably 0% or more, particularly preferably 0.1% or more, and further preferably 0.2% or more.

When the optical function of the optically functional pressure sensitive adhesive layer is coloring, the total luminous transmittance (value measured according to JIS K7361-1: 1997; here and hereinafter) of the composite pressure sensitive adhesive layer may be preferably 90% or less, more preferably 78% or less, particularly preferably 66% or less, and further preferably 54% or less. This allows the degree of coloring to be satisfactory. On the other hand, considering the visibility of the display body, the lower limit of the total luminous transmittance of the composite pressure sensitive adhesive layer may be preferably 5% or more, also preferably 25% or more, particularly preferably 35% or more, and further preferably 45% or more.

When the optical function of the optically functional pressure sensitive adhesive layer is light diffusion, the total luminous transmittance of the composite pressure sensitive adhesive layer may be preferably 70% or more, also preferably 85% or more, particularly preferably 95% or more, and further preferably 99% or more. This allows the visibility of the display body to be satisfactory. On the other hand, the upper limit of the total luminous transmittance of the composite pressure sensitive adhesive layer is not particularly limited, but may be ordinarily 100%.

When the optical function of the optically functional pressure sensitive adhesive layer is coloring, the total luminous transmittance of the optically functional pressure sensitive adhesive layer may be preferably 90% or less, also preferably 78% or less, particularly preferably 66% or less, and further preferably 54% or less. This allows the degree of coloring to be satisfactory. Considering the visibility of the display body, the above total luminous transmittance may be preferably 5% or more, more preferably 25% or more, particularly preferably 35% or more, and further preferably 45% or more.

When the optical function of the optically functional pressure sensitive adhesive layer is light diffusion, the total luminous transmittance of the optically functional pressure sensitive adhesive layer may be preferably 70% or more, more preferably 85% or more, particularly preferably 95% or more, and further preferably 99% or more. This allows the visibility of the display body to be satisfactory. The upper limit of the total luminous transmittance of the above optically functional pressure sensitive adhesive layer is not particularly limited, but may be ordinarily 100%.

The total luminous transmittance of the transparent pressure sensitive adhesive layer may be preferably 70% or more, also preferably 85% or more, particularly preferably 95% or more, and further preferably 99% or more. This allows the visibility of the display to be satisfactory. On the other hand, the upper limit of the total luminous transmittance of the transparent pressure sensitive adhesive layer is not particularly limited, but may be ordinarily 100%.

When the optically functional adhesive layer/transparent adhesive layer is active energy ray curable, the aforementioned physical property values can be readily satisfied even after the pressure sensitive adhesive layer is cured with active energy rays.

The storage elastic modulus at 23° C. of the pressure sensitive adhesive constituting the optically functional pressure sensitive adhesive layer may be preferably 0.01 MPa or more, more preferably 0.03 MPa or more, particularly preferably 0.05 MPa or more, and further preferably 0.06 MPa or more. From another aspect, the above storage elastic modulus may be preferably 0.5 MPa or less, more preferably 0.2 MPa or less, particularly preferably 0.1 MPa or less, and further preferably 0.08 MPa or less. preferable. When the storage elastic modulus at 23° C. of the pressure sensitive adhesive constituting the optically functional pressure sensitive adhesive layer falls within the above range, it is possible to more effectively suppress uneven optical function.

The storage elastic modulus at 23° C. of the pressure sensitive adhesive constituting the transparent pressure sensitive adhesive layer may be preferably 0.01 MPa or more, more preferably 0.03 MPa or more, particularly preferably 0.05 MPa or more, and further preferably 0.06 MPa or more. From another aspect, the above storage elastic modulus may be preferably 0.5 MPa or less, particularly preferably 0.2 MPa or less, and further preferably 0.1 MPa or less. When the storage elastic modulus at 23° C. of the pressure sensitive adhesive constituting the transparent pressure sensitive adhesive layer falls within the above range, uneven optical function can be more effectively suppressed.

When the pressure sensitive adhesive constituting the optically functional pressure sensitive adhesive layer is an active energy ray curable pressure sensitive adhesive, the storage elastic modulus at 23° C. of the pressure sensitive adhesive after being cured with active energy rays may be preferably 0.02 MPa or more, more preferably 0.05 MPa or more, particularly preferably 0.08 MPa or more, and further preferably 0.12 MPa or more. From another aspect, the above storage elastic modulus may be preferably 1 MPa or less, more preferably 0.5 MPa or less, particularly preferably 0.2 MPa or less, and further preferably 0.15 MPa or less. When the storage elastic modulus at 23° C. of the pressure sensitive adhesive constituting the optically functional pressure sensitive adhesive layer falls within the above range, it is possible to effectively suppress the uneven optical function and improve the step followability under high-temperature and high-humidity conditions.

When the pressure sensitive adhesive constituting the transparent pressure sensitive adhesive layer is an active energy ray curable pressure sensitive adhesive, the storage elastic modulus at 23° C. of the pressure sensitive adhesive after being cured with active energy rays may be preferably 0.02 MPa or more, more preferably 0.05 MPa or more, particularly preferably 0.08 MPa or more, and further preferably 0.12 MPa or more. From another aspect, the above storage elastic modulus may be preferably 1 MPa or less, more preferably 0.5 MPa or less, particularly preferably 0.2 MPa or less, and further preferably 0.15 MPa or less. When the storage elastic modulus at 23° C. of the pressure sensitive adhesive constituting the transparent pressure sensitive adhesive layer falls within the above range, it is possible to effectively suppress the uneven optical function and improve the step followability under high-temperature and high-humidity conditions.

As used in the present specification, the storage elastic modulus refers to a value measured at a measurement frequency of 1 Hz by a torsional shear method according to JIS K7244-6. Specifically, it is as described in the Testing Example, which will be described later.

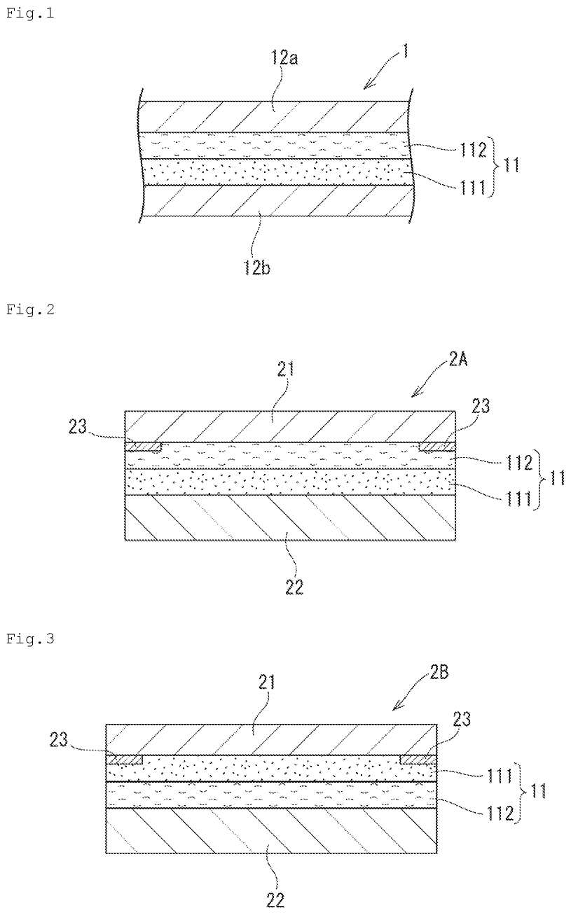

FIG. 1 illustrates a specific configuration as an example of the pressure sensitive adhesive sheet according to the present embodiment.

As illustrated in FIG. 1, a pressure sensitive adhesive sheet 1 is composed of a first release sheet 12a, a second release sheet 12b, and a composite pressure sensitive adhesive layer 11 that is interposed between the two release sheets 12a and 12b so as to be in contact with release surfaces of the two release sheets 12a and 12b. The first release sheet 12a is a release sheet to be released first, and the second release sheet 12b is a release sheet to be released later. As used in the present specification, the release surface of a release sheet refers to a surface having releasability in the release sheet, and examples of the release surface include both a surface subjected to release treatment and a surface that exhibits releasability even without being subjected to release treatment.

The composite pressure sensitive adhesive layer 11 in the present embodiment is composed of a transparent pressure sensitive adhesive layer 111 and an optically functional pressure sensitive adhesive layer 112. In the composite pressure sensitive adhesive layer 11, the optically functional pressure sensitive adhesive layer 112 may be located so as to be in contact with the first release sheet 12a, and the transparent pressure sensitive adhesive layer 111 may be located so as to be in contact with the second release sheet 12b. In the present embodiment, the first release sheet 12a may be omitted.

1. Each member
1-1. Composite Pressure Sensitive Adhesive layer

The optically functional pressure sensitive adhesive layer 112 may be composed of a pressure sensitive adhesive that exhibits a desired optical function. For example, when the optical function is coloring, the optically functional pressure sensitive adhesive layer 112 may be preferably composed of a pressure sensitive adhesive that contains a colorant. Additionally or alternatively, when the optical function is light diffusion, the optically functional pressure sensitive adhesive layer 112 may be preferably composed of a pressure sensitive adhesive that contains light-diffusing fine particles.

On the other hand, the transparent pressure sensitive adhesive layer 111 does not have the optical function possessed by the above optically functional adhesive layer 112. For example, when the optical function is coloring or light diffusion, the transparent pressure sensitive adhesive layer 111 may be preferably composed of a pressure sensitive adhesive that contains no colorant and no light-diffusing fine particles, and may also be preferably colorless and transparent.

“Containing no colorant” means “substantially containing no colorant,” and it encompasses not only a case in which a colorant is not contained at all, but also a case in which a colorant is contained in an amount that does not impair the effects of the present embodiment. The amount may be preferably 0.1 mass % or less, particularly preferably 0.01 mass % or less, further preferably 0.001 mass % or less, and most preferably 0 mass %.

Likewise, “containing no light-diffusing fine particles” means “substantially containing no light-diffusing fine particles,” and it encompasses not only a case in which light-diffusing fine particles are not contained at all, but also a case in which light-diffusing fine particles are contained in an amount that does not impair the effects of the present embodiment. The amount may be preferably 0.1 mass % or less, particularly preferably 0.01 mass % or less, further preferably 0.001 mass % or less, and most preferably 0 mass %.

The types of pressure sensitive adhesives constituting the optically functional pressure sensitive adhesive layer 112 and the transparent pressure sensitive adhesive layer 111 of the pressure sensitive adhesive sheet 1 according to the present embodiment are not particularly limited, and examples thereof include acrylic-based pressure sensitive adhesives, polyester-based pressure sensitive adhesives, polyurethane-based pressure sensitive adhesives, rubber-based pressure sensitive adhesives, and silicone-based pressure sensitive adhesives. The pressure sensitive adhesive may be any of emulsion type, solvent type, or non-solvent type and may also be crosslinked type or non-crosslinked type. Among these, acrylic-based pressure sensitive adhesives may be preferred because they are excellent in the pressure sensitive adhesive physical properties, optical properties, etc.

The acrylic-based pressure sensitive adhesives may be active energy ray curable or active energy ray non-curable. As the acrylic-based pressure sensitive adhesives, crosslinking type ones may be preferred, and thermal crosslinking type ones may be further preferred.

The type of the pressure sensitive adhesive constituting the optically functional pressure sensitive adhesive layer 112 and the type of the pressure sensitive adhesive constituting the transparent pressure sensitive adhesive layer 111 may be the same or different. For example, one of them may be an active energy ray curable acrylic-based pressure sensitive adhesive while the other may be an active energy ray non-curable acrylic-based pressure sensitive adhesive. Even when both are common in the active energy ray curable acrylic-based pressure sensitive adhesive or the active energy ray non-curable acrylic pressure sensitive adhesive, the composition of the pressure sensitive adhesive or the monomer composition of the main polymer may be different.

The pressure sensitive adhesive constituting the optically functional pressure sensitive adhesive layer 112 and the pressure sensitive adhesive constituting the transparent pressure sensitive adhesive layer 111 may be preferably those obtained by crosslinking a pressure sensitive adhesive composition that specifically contains a (meth)acrylic ester polymer (A) and particularly preferably those obtained by crosslinking a pressure sensitive adhesive composition that contains a (meth)acrylic ester polymer (A) and a crosslinker (B) (such a pressure sensitive adhesive composition may be referred to as a “pressure sensitive adhesive composition P,” hereinafter). When the optical function is coloring in the optically functional pressure sensitive adhesive layer 112, the pressure sensitive adhesive composition P for the optically functional pressure sensitive adhesive layer 112 may preferably further contain a colorant (C). When the optical function is light diffusion in the optically functional pressure sensitive adhesive layer 112, the pressure sensitive adhesive composition P for the optically functional pressure sensitive adhesive layer 112 may preferably further contain light-diffusing fine particles (D). When using an active energy ray curable pressure sensitive adhesive as the above pressure sensitive adhesive, the pressure sensitive adhesive composition P may preferably further contain an active energy ray curable component (E).

The pressure sensitive adhesive obtained from such a pressure sensitive adhesive composition P can exhibit excellent optical properties, adhesive strength, etc. As used in the present specification, the term “(meth)acrylic acid” refers to both the acrylic acid and the methacrylic acid. The same applies to other similar terms. As used in the present specification, the term “polymer” encompasses the concept of a “copolymer.”

### (1) Components of Pressure Sensitive Adhesive Composition

### (1-1) (Meth)acrylic Ester Polymer (A)

The (meth)acrylic ester polymer (A) in the present embodiment may preferably contain, as a monomer unit that constitutes the polymer, a reactive group-containing monomer having in the molecule a reactive group that reacts with the crosslinker (B). The reactive group derived from the reactive group-containing monomer reacts with the crosslinker (B) to form a crosslinked structure (three-dimensional network structure), and a pressure sensitive adhesive having desired cohesive strength can be obtained.

Preferred examples of the above reactive group-containing monomer include a monomer having a hydroxyl group in the molecule (hydroxyl group-containing monomer), a monomer having a carboxy group in the molecule (carboxy group-containing monomer), and a monomer having an amino group in the molecule (amino group-containing monomer). Among these, the hydroxyl group-containing monomer or the carboxy group-containing monomer may be preferred because it is excellent in the reactivity with the crosslinker (B). It may also be preferred to use the hydroxyl group-containing monomer and the carboxy group-containing monomer in combination.

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth) acrylate, 3-hydroxybutyl (meth)acrylate, and 4-hydroxybutyl (meth)acrylate. Among these, hydroxyalkyl (meth)acrylates having a hydroxyalkyl group whose carbon number is 1 to 4 may be preferred from the viewpoints of the reactivity of the hydroxyl group in the obtained (meth)acrylic ester polymer (A) with the crosslinker (B) and the copolymerizability with other monomers. Specifically, for example, 2-hydroxyethyl (meth) acrylate, 4-hydroxybutyl (meth)acrylate, or the like may be preferred, and 2-hydroxyethyl acrylate or 4-hydroxybutyl acrylate may be particularly preferred. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. Among these, acrylic acid may be preferred from the viewpoints of the reactivity of the carboxy group in the obtained (meth)acrylic ester polymer (A) with the crosslinker (B) and the copolymerizability with other monomers. These may each be used alone or two or more types may also be used in combination.

Examples of the amino group-containing monomer include aminoethyl (meth)acrylate and n-butylaminoethyl (meth)acrylate. These may each be used alone or two or more types may also be used in combination. Nitrogen atom-containing monomers, which will be described later, are excluded from the amino group-containing monomers.

The (meth)acrylic ester polymer (A) may preferably contain, as the lower limit, 5 mass % or more, particularly preferably 10 mass % or more, and further preferably 15 mass % or more of the reactive group-containing monomer as a monomer unit that constitutes the polymer. From another aspect, the (meth)acrylic ester polymer (A) may preferably contain, as the upper limit, 35 mass % or less, particularly preferably mass % or less, and further preferably 25 mass % or less of the reactive group-containing monomer as a monomer unit that constitutes the polymer. When the (meth)acrylic ester polymer (A) contains the reactive group-containing monomer in the above amount as a monomer unit, a good crosslinked structure is formed in the obtained pressure sensitive adhesive so that the desired cohesive strength can be obtained. Moreover, when the colorant (C) or the light-diffusing fine particles (D) are contained, the dispersibility of the colorant (C) or light-diffusing fine particles (D) in the obtained pressure sensitive adhesive tends to be satisfactory. This allows the obtained pressure sensitive adhesive to exhibit suitable cohesive strength and to have good repeatability and uniformity of optical functions.

It is also preferred that the (meth)acrylic ester polymer (A) should not contain a carboxy group-containing monomer as a monomer unit that constitutes the polymer. The carboxyl group is an acid component, so troubles due to the acid may occur on an object to which the pressure sensitive adhesive is bonded, but the absence of a carboxyl group-containing monomer can suppress the troubles (such as corrosion and resistance value change) due to the acid even when there are transparent conductive films such as tin-doped indium oxide (ITO), metal films, or the like. Fortunately, however, it may be permissible to contain a certain amount of the carboxy group-containing monomer to an extent that such problems do not occur. Specifically, the (meth)acrylic ester polymer (A) may be permitted to contain, as a monomer unit, the carboxy group-containing monomer in an amount of 0.1 mass % or less, preferably 0.01 mass % or less, and further preferably 0.001 mass % or less.

The (meth)acrylic ester polymer (A) may preferably contain (meth)acrylic alkyl ester as a monomer unit that constitutes the polymer. This can develop good pressure sensitive adhesive properties. The alkyl group may be linear or branched.

From the viewpoint of the pressure sensitive adhesive properties, (meth)acrylic alkyl ester whose carbon number of alkyl group is 1 to 20 may be preferred as the (meth)acrylic alkyl ester. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate. Among these, from the viewpoint of more improving the pressure sensitive adhesive properties, (meth)acrylic alkyl ester whose carbon number of alkyl group is 1 to 8 may be preferred, methyl (meth)acrylate, n-butyl (meth)acrylate, or 2-ethylhexyl (meth)acrylate may be particularly preferred, and methyl methacrylate, n-butyl acrylate, or 2-ethylhexyl acrylate may be particularly preferred. These may each be used alone or two or more types may also be used in combination.

The (meth)acrylic ester polymer (A) may preferably contain 45 mass % or more, particularly preferably 55 mass % or more, and further preferably 65 mass % or more of the (meth)acrylic alkyl ester as a monomer unit that constitutes the polymer. When the lower limit of the content of the (meth)acrylic alkyl ester satisfies the above, the (meth)acrylic ester polymer (A) can exhibit suitable pressure sensitive adhesive properties. Moreover, when the colorant (C) or the light-diffusing fine particles (D) are contained, the dispersibility of the colorant (C) or light-diffusing fine particles (D) in the pressure sensitive adhesive tends to be satisfactory, and the (meth)acrylic ester polymer (A) can be prevented from impairing the desired pressure sensitive adhesive properties. This allows the obtained pressure sensitive adhesive to exhibit suitable pressure sensitive adhesive properties and to have good repeatability and uniformity of optical functions. On the other hand, the (meth)acrylic ester polymer (A) may preferably contain 95 mass % or less, more preferably 90 mass % or less, particularly preferably 85 mass % or less, and further preferably 80 mass % or less of the (meth)acrylic alkyl ester as a monomer unit that constitutes the polymer. When the upper limit of the content of the (meth)acrylic alkyl ester satisfies the above, a suitable amount of other monomer components such as a reactive functional group-containing monomer can be introduced into the (meth)acrylic ester polymer (A).

The above (meth)acrylic ester polymer (A) may also preferably contain a monomer having an alicyclic structure in the molecule (alicyclic structure-containing monomer) as a monomer unit that constitutes the polymer. Since the alicyclic structure-containing monomer is bulky, it is presumed that the presence of such monomers in the polymer widens the distance between the polymers, and the obtained pressure sensitive adhesive can be made excellent in the flexibility. This allows the pressure sensitive adhesive to have excellent step followability, and it is possible to readily suppress the occurrence of uneven optical function due to irregularities.

The carbon ring of the alicyclic structure in the alicyclic structure-containing monomer may have a saturated structure or may also have an unsaturated bond as a part. The alicyclic structure may be a monocyclic alicyclic structure or may also be a polycyclic alicyclic structure such as a bicyclic or tricyclic structure. From the viewpoints of optimizing the distance between molecules of the obtained (meth)acrylic ester polymer (A) and imparting higher stress relaxation properties to the pressure sensitive adhesive, the above alicyclic structure may be preferably a polycyclic alicyclic structure (polycyclic structure). In consideration of compatibility between the (meth)acrylic ester polymer (A) and other components, the above polycyclic structure may be particularly preferably bicyclic to tetracyclic. From the viewpoint of imparting higher stress relaxation properties to the pressure sensitive adhesive as described above, the carbon number of the alicyclic structure (the number of all carbon atoms in a portion that forms the ring, and when two or more rings are independently present, the total carbon number) may be preferably 5 or more in general and particularly preferably 7 or more. On the other hand, the upper limit of the carbon number of the alicyclic structure is not particularly limited, but may be preferably 15 or less and particularly preferably or less from the viewpoint of compatibility as described above.

Specific examples of the above alicyclic structure-containing monomer include cyclohexyl (meth)acrylate, dicyclopentanyl (meth)acrylate, adamantyl (meth)acrylate, isobornyl (meth)acrylate, dicyclopentenyl (meth)acrylate, and dicyclopentenyloxyethyl (meth)acrylate, among which dicyclopentanyl (meth)acrylate (carbon number of alicyclic structure: 10), adamantyl (meth)acrylate (carbon number of alicyclic structure: 10), or isobornyl (meth)acrylate (carbon number of alicyclic structure: 7) may be preferred because they exhibit more excellent step followability. In particular, isobornyl (meth)acrylate may be preferred, and isobornyl acrylate may be further preferred. These may each be used alone or two or more types may also be used in combination.

When containing an alicyclic structure-containing monomer as a monomer unit that constitutes the polymer, the (meth)acrylic ester polymer (A) may preferably contain 1 mass % or more, particularly preferably 4 mass % or more, and further preferably 8 mass % or more of the alicyclic structure-containing monomer. From another aspect, the (meth)acrylic ester polymer (A) may preferably contain 30 mass % or less, particularly preferably 20 mass % or less, and further preferably 10 mass % or less of the alicyclic structure-containing monomer as a monomer unit that constitutes the polymer. When the content of the alicyclic structure-containing monomer falls within the above range, the obtained pressure sensitive adhesive can have excellent step followability, and it is possible to readily suppress the occurrence of uneven optical function due to irregularities.

Additionally or alternatively, the (meth)acrylic ester polymer (A) may also preferably contain a nitrogen atom-containing monomer as a monomer unit that constitutes the polymer. By allowing a nitrogen atom-containing monomer to exist in the polymer as a constituent unit, the pressure sensitive adhesive is imparted with a predetermined polarity and can have excellent affinity even for an adherend having a certain degree of polarity, such as glass. As the above nitrogen atom-containing monomer, from the viewpoint of imparting appropriate rigidity to the (meth)acrylic ester polymer (A), a monomer having a nitrogen-containing heterocyclic ring may be preferred. Additionally or alternatively, from the viewpoint of increasing the degree of freedom of the portion derived from the above nitrogen atom-containing monomer in a high-dimensional structure of the pressure sensitive adhesive under construction, it is preferred that the nitrogen atom-containing monomer should not contain a reactive unsaturated double bond group other than one polymerizable group used during the polymerization for forming the (meth)acrylic ester polymer (A).

Examples of the monomer having a nitrogen-containing heterocycle include N-(meth)acryloyl morpholine, N-vinyl-2-pyrrolidone, N-(meth)acryloyl pyrrolidone, N-(meth)acryloyl piperidin, N-(meth)acryloyl pyrrolidine, N-(meth)acryloyl aziridine, aziridinyl ethyl (meth)acrylate, 2-vinylpyridine, 4-vinylpyridine, 2-vinylpyrazine, 1-vinylimidazole, N-vinylcarbazole, and N-vinylphthalimide, among which N-(meth)acryloylmorpholine exhibiting more excellent adhesive strength may be preferred, and N-acryloylmorpholine may be particularly preferred. These may each be used alone or two or more types may also be used in combination.

When containing a nitrogen atom-containing monomer as a monomer unit that constitutes the polymer, the (meth)acrylic ester polymer (A) may preferably contain 1 mass % or more, particularly preferably 2 mass % or more, and further preferably 4 mass % or more of the nitrogen atom-containing monomer. From another aspect, the (meth)acrylic ester polymer (A) may preferably contain 24 mass % or less, particularly preferably 16 mass % or less, and further preferably 8 mass % or less of the nitrogen atom-containing monomer as a monomer unit that constitutes the polymer. When the content of the nitrogen atom-containing monomer falls within the above range, the obtained pressure sensitive adhesive can sufficiently exhibit excellent adhesive strength to glass.

The (meth)acrylic ester polymer (A) may contain other monomers, if desired, as a monomer unit that constitutes the polymer. As other monomers, monomers containing no reactive functional groups may be preferred so as not to inhibit the aforementioned effects of the reactive functional group-containing monomers. Examples of such monomers include alkoxyalkyl (meth)acrylates such as methoxyethyl (meth)acrylate and ethoxyethyl (meth)acrylate, vinyl acetate, and styrene. These may each be used alone or two or more types may also be used in combination.

The (meth)acrylic ester polymer (A) may be preferably a linear polymer. Such a linear polymer may promote the entanglement of molecular chains, and improvement in the cohesive force can be expected; therefore, a pressure sensitive adhesive excellent in the step followability under high-temperature and high-humidity conditions can readily be obtained.

The (meth)acrylic ester polymer (A) may be preferably a solution polymerization product obtained by a solution polymerization method. Being a solution polymerization product allows a high molecular-weight polymer to be easily obtained, and improvement in the cohesive force can be expected; therefore, a pressure sensitive adhesive excellent in the step followability under high-temperature and high-humidity conditions can readily be obtained. Moreover, when the colorant (C) or the light-diffusing fine particles (D) are contained, the dispersibility of the colorant (C) or light-diffusing fine particles (D) in the obtained pressure sensitive adhesive tends to be satisfactory, and the obtained pressure sensitive adhesive can exhibit suitable cohesive strength and can have good repeatability and uniformity of optical functions.

The polymerization form of the (meth)acrylic ester polymer (A) may be a random copolymer or may also be a block copolymer.

The weight-average molecular weight of the (meth)acrylic ester polymer (A) may be preferably 200,000 or more, more preferably 300,000 or more, and particularly preferably 400,000 or more as the lower limit and may be further preferably 500,000 or more as the lower limit from the viewpoint of the dispersibility of the colorant (C) or the light-diffusing fine particles (D). When the lower limit of the weight-average molecular weight of the (meth)acrylic ester polymer (A) satisfies the above, the obtained pressure sensitive adhesive can readily have suitable values such as gel fraction and storage elastic modulus and can be more excellent in the step followability under high-temperature and high-humidity conditions, and the uneven optical function can be readily suppressed. Moreover, the dispersibility of the colorant (C) or light-diffusing fine particles (D) in the pressure sensitive adhesive tends to be satisfactory, and the obtained pressure sensitive adhesive can therefore have good repeatability and uniformity of optical functions.

From another aspect, the weight-average molecular weight of the (meth)acrylic ester polymer (A) may be preferably 1,500,000 or less, more preferably 1,200,000 or less, particularly preferably 1,000,000 or less, and further preferably 800,000 or less as the upper limit. When the upper limit of the weight-average molecular weight of the (meth)acrylic ester polymer (A) satisfies the above, the obtained pressure sensitive adhesive can readily have suitable values such as gel fraction and storage elastic modulus and can be more excellent in the step followability, and the uneven optical function can be readily suppressed. As used in the present specification, the weight-average molecular weight refers to a standard polystyrene equivalent value that is measured by using a gel permeation chromatography (GPC) method.

In the pressure sensitive adhesive composition P, one type of the (meth)acrylic ester polymer (A) may be used alone or two or more types may also be used in combination.

### (1-2) Crosslinker (B)

The crosslinker (B) can crosslink the (meth)acrylic ester polymer (A) by heating of the pressure sensitive adhesive composition P and can satisfactorily form a three-dimensional network structure. This can improve the cohesive force of the obtained pressure sensitive adhesive, and the step followability under high-temperature and high-humidity conditions can be excellent. Moreover, the obtained pressure sensitive adhesive can readily have suitable values such as gel fraction and storage elastic modulus, and the uneven optical function can readily be suppressed.

It may be sufficient that the above crosslinker (B) is reactive with a reactive group possessed by the (meth)acrylic ester polymer (A). Examples of the crosslinker (B) include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker. When the reactive group possessed by the (meth)acrylic ester polymer (A) is a hydroxyl group, it may be preferred to use, among the above, the isocyanate-based crosslinker having excellent reactivity with the hydroxyl group. When the reactive group possessed by the (meth)acrylic ester polymer (A) is a carboxyl group, it may be preferred to use, among the above, the epoxy-based crosslinker having excellent reactivity with the carboxyl group. When the hydroxyl group and the carboxy group coexist as reactive groups possessed by the (meth)acrylic ester polymer (A), the isocyanate-based crosslinker and the epoxy-based crosslinker may be used in combination, or a crosslinker that is preferred for the high content of a reactive group in the (meth)acrylic ester polymer (A) may only be used. One type of the crosslinker (B) may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, from the viewpoint of reactivity with hydroxyl groups, trimethylolpropane-modified aromatic polyisocyanate may be preferred, and trimethylolpropane-modified tolylene diisocyanate and trimethylolpropane-modified xylylene diisocyanate may be particularly preferred.

Examples of the epoxy-based crosslinker include 1,3-bis(N,N-diglycidylaminomethyl)cyclohexane, N,N,N′,N′-tetraglycidyl-m-xylylenediamine, ethylene glycol diglycidyl ether, 1,6-hexanediol diglycidyl ether, trimethylolpropane diglycidyl ether, diglycidylaniline, and diglycidylamine. Among these, 1,3-bis(N,N-diglycidylaminomethyl)cyclohexane may be preferred from the viewpoint of reactivity with carboxy groups.

The content of the crosslinker (B) in the pressure sensitive adhesive composition P may be preferably 0.01 mass parts or more, particularly preferably 0.05 mass parts or more, and further preferably 0.1 mass parts or more with respect to 100 mass parts of the (meth)acrylic ester polymer (A). From another aspect, the content may be preferably 10 mass parts or less, more preferably 5 mass parts or less, particularly preferably 1 mass part or less, and further preferably 0.4 mass parts or less. When the content of the crosslinker (B) falls within the above range, the obtained pressure sensitive adhesive can readily have suitable values such as gel fraction, storage elastic modulus, and adhesive strength, can be more excellent in the step followability under high-temperature and high-humidity conditions, and can readily suppress the uneven optical function.

### (1-3) Colorant (C)

The colorant (C) may be sufficient if the optically functional pressure sensitive adhesive layer 112 in the composite pressure sensitive adhesive layer 11 satisfies the aforementioned physical properties.

The colorant (C) may be a pigment or a dye. The pigment may be an inorganic pigment or an organic pigment. From the viewpoint of the durability of the obtained pressure sensitive adhesive, inorganic pigments may be preferred. The color of the colorant can be appropriately selected depending on the purpose. For example, when a sense of unity with a peripheral member is needed, the colorant may be selected in accordance with the color of the peripheral member. In general, dark or deep colors such as black, brown, navy blue, purple, and blue may be preferred, and black may be particularly preferred.

Examples of inorganic pigments include carbon black-based pigments, cobalt-based pigments or dyes, iron-based pigments or dyes, chromium-based pigments or dyes, titanium-based pigments or dyes, vanadium-based pigments or dyes, zirconium-based pigments or dyes, molybdenum-based pigments or dyes, ruthenium-based pigments or dyes, platinum-based pigments or dyes, ITO (indium tin oxide)-based pigments or dyes, and ATO (antimony tin oxide)-based pigments or dyes.

Examples of organic pigments and organic dyes include aminium-based pigments or dyes, cyanine-based pigments or dyes, merocyanine-based pigments or dyes, croconium-based pigments or dyes, squarylium-based pigments or dyes, azulenium-based pigments or dyes, polymethine-based pigments or dyes, naphthoquinone-based pigments or dyes, pyrylium-based pigments or dyes, phthalocyanine-based pigments or dyes, naphthalocyanine-based pigments or dyes, naphtolactam-based pigments or dyes, azo-based pigments or dyes, condensed azo-based pigments or dyes, indigo-based pigments or dyes, perinone-based pigments or dyes, perylene-based pigments or dyes, dioxazine-based pigments or dyes, quinacridone-based pigments or dyes, isoindolinone-based pigments or dyes, quinophthalone-based pigments or dyes, pyrrole-based pigments or dyes, thioindigo-based pigments or dyes, metal complex-based pigments or dyes (metal complex salt pigments), dithiol metal complex-based pigments or dyes, indolephenol-based pigments or dyes, triarylmethane-based pigments or dyes, anthraquinone-based pigments or dyes, dioxazine-based pigments or dyes, naphthol-based pigments or dyes, azomethine-based pigments or dyes, benzimidazolone-based pigments or dyes, pyranthrone-based pigments or dyes, and threne-based pigments or dyes.

Examples of black pigments include carbon black, copper oxide, triiron tetraoxide, manganese dioxide, aniline black, and activated carbon. Examples of black dyes include high-concentration vegetable dyes and azo-based dyes.

The above pigments or dyes can be appropriately mixed and used depending on the purpose.

Among the above colorants, carbon black-based pigments, nigrosine-based black dyes, and chromate-based black dyes may be preferred from the viewpoint of facilitating a sense of unity with peripheral members. The surface of the carbon black may be or may not be subjected to a predetermined treatment (e.g., solvent-affinity treatment).

When the above colorant (C) is diluted 10,000 times with ethyl acetate to obtain a liquid and the haze value of the liquid at a wavelength of 780 nm and the haze value of the liquid at a wavelength of 380 nm are averaged to obtain an average haze, the lower limit of the average haze may be preferably 1% or more and 60% or less, particularly preferably 2% or more and 40% or less, further preferably 3% or more and 20% or less, and also preferably 4% or more and 10% or less. By using an appropriate amount of such a colorant (C), the aforementioned optical properties can be suitable in the obtained composite pressure sensitive adhesive layer 11 and optically functional pressure sensitive adhesive layer 112.

Additionally or alternatively, when the above colorant (C) is diluted 10,000 times with ethyl acetate to obtain a liquid and the haze value of the liquid at a wavelength of 780 nm and the haze value of the liquid at a wavelength of 380 nm are compared to obtain a difference, the value of the difference may be preferably 30 points or less, more preferably 25 points or less, particularly preferably 20 points or less, further preferably 16 points or less, and most preferably 10 points or less. From another aspect, the lower limit of the above difference between the haze values may be 0 point, but may be preferably 1 point or more, particularly preferably 3 points or more, and further preferably 5 points or more. By using an appropriate amount of such a colorant (C), the aforementioned optical properties can be suitable in the obtained composite pressure sensitive adhesive layer 11 and optically functional pressure sensitive adhesive layer 112.

When the above colorant (C) is diluted 10,000 times with ethyl acetate to obtain a liquid, the haze value of the liquid at a wavelength of 780 may be preferably 0.1% to 50%, particularly preferably 1% to 30%, further preferably 1.5% to 20%, and most preferably 2% to 10%. Additionally or alternatively, the haze value of the liquid at a wavelength of 380 may be preferably 1% to 60%, particularly preferably 5% to 40%, further preferably 8% to 30%, and most preferably 10% to 20%. This allows the above difference between the haze values to be readily satisfied.

Additionally or alternatively, when the above colorant (C) is diluted 10,000 times with ethyl acetate to obtain a liquid and the haze values of the liquid at 5 nm-pitch wavelengths within a wavelength region of 380 nm to 780 nm (i.e., at wavelengths of 380 nm, 385 nm, 390 nm, . . . , 775 nm, and 780 nm) are determined, the standard deviation of the haze values may be preferably 0.1 or more and 10 or less, more preferably 0.5 or more and 8 or less, particularly preferably 1 or more and 5 or less, and further preferably 1.2 or more and 2 or less. When the above conditions are satisfied, by using an appropriate amount of such a colorant (C), the aforementioned optical properties can be suitable in the obtained composite pressure sensitive adhesive layer 11 and optically functional pressure sensitive adhesive layer 112.

In the optically functional pressure sensitive adhesive layer 112, the content of the colorant (C) with respect to 100 mass parts of the (meth)acrylic ester polymer (A) may be preferably 0.01 mass parts or more, more preferably 0.1 mass parts or more, particularly preferably 0.3 mass parts or more, and further preferably 0.5 mass parts or more. When the above conditions are satisfied, the aforementioned straightforward transmittance of light rays having a wavelength of 550 nm can be readily satisfied, and excellent concealability can be readily exhibited when the display body is turned off. On the other hand, from the viewpoints of readily controlling the haze to a desired value and readily exhibiting excellent visibility (ease of visual recognition of images/videos) when the display body is turned off, the above content may be preferably 8 mass parts or less, more preferably 4 mass parts or less, particularly preferably 2 mass parts or less, and further preferably 1 mass part or less. When the content of the colorant (C) falls within the above range, coloring can be sufficiently achieved without deteriorating the durability or the like of the obtained pressure sensitive adhesive, and desired concealability and visibility can be exhibited.

(1-4) Light-diffusing Fine Particles (D) The light-diffusing fine particles (D) may be sufficient if the composite pressure sensitive adhesive layer 11 and the optically functional pressure sensitive adhesive layer 112 can satisfy the aforementioned physical properties.

Examples of the light-diffusing fine particles (D) include: inorganic fine particles such as silica, calcium carbonate, aluminum hydroxide, magnesium hydroxide, clay, talc, and titanium dioxide; organic transparent fine particles such as acrylic resins, polystyrene resins, polyethylene resins, and epoxy resins; and fine particles composed of a silicon-containing compound having an intermediate structure between inorganic one and organic one, such as silicone resins (e.g., Tospearl series available from Momentive Performance Materials Japan). Among these, fine particles composed of silicone resin may be preferred. This allows the aforementioned straightforward transmittance of light rays having a wavelength of 550 nm to be readily satisfied. One type of the above light-diffusing fine particles (D) may be used alone, or two or more type may also be used in combination.

As for the shape of the light-diffusing fine particles (D), spherical fine particles with uniform light diffusion may be preferred. The average particle diameter of the light-diffusing fine particles (D) as determined by a centrifugal sedimentation light transmission method may be preferably 1.0 μm or more, particularly preferably 2.0 μm or more, and further preferably 3.0 μm or more as the lower limit. When the lower limit of the above average particle diameter satisfies the above, the desired haze can be readily developed. On the other hand, the above average particle diameter may be preferably 10 μm or less, particularly preferably 8 μm or less, and further preferably 6 μm or less as the upper limit. When the upper limit of the above average particle diameter satisfies the above, it is easy to prevent the haze value from becoming too high, and a high-definition display image can be satisfactorily displayed.

The average particle diameter determined by the above centrifugal sedimentation light transmission method is a value measured using an automated centrifugal particle size distribution analyzer (CAPA-700 available from HORIBA, Ltd.) with a sample for measurement obtained by sufficiently stirring 1.2 g of fine particles and 98.8 g of isopropyl alcohol.

The content of the light-diffusing fine particles (D) in the pressure sensitive adhesive composition P may be any amount that can satisfy the aforementioned physical properties. Specifically, the content of the light-diffusing fine particles (D) may be preferably 1 mass % or more, more preferably 2 mass % or more, particularly preferably 3 mass % or more, and further preferably 4 mass % or more. This allows the aforementioned straightforward transmittance of light rays having a wavelength of 550 nm to be readily satisfied, and suitable light diffusion can be readily obtained. From another aspect, the content of the light-diffusing fine particles (D) may be preferably 20 mass % or less, more preferably 15 mass % or less, particularly preferably 10 mass % or less, and further preferably 6 mass % or less. This allows the aforementioned haze value and storage elastic modulus to be readily satisfied.

### (1-5) Active Energy Ray Curable Component (E)

When the pressure sensitive adhesive constituting the optically functional pressure sensitive adhesive layer 112 or the transparent pressure sensitive adhesive layer 111 is an active energy ray curable pressure sensitive adhesive, the pressure sensitive adhesive composition P may preferably contain an active energy ray curable component (E). In a pressure sensitive adhesive obtained by crosslinking the pressure sensitive adhesive composition P and curing it with active energy rays, it is considered that molecules of the active energy ray curable component (E) are polymerized with one another and the polymerized active energy ray curable component (E) is entangled with the crosslinked structure (three-dimensional network structure) of the (meth)acrylic ester polymer (A). The pressure sensitive adhesive having such a high-dimensional structure can have excellent step followability under high-temperature and high-humidity conditions.

The active energy ray curable component (E) is not particularly limited, provided that it can be cured by irradiation with active energy rays and can obtain the above effects, and may be any of a monomer, an oligomer, and a polymer or may also be a mixture thereof. Among these, a polyfunctional acrylate-based monomer may be preferred because it is more excellent in the durability.

Examples of the polyfunctional acrylate-based monomer include bifunctional ones such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, tricyclodecanedimethanol di(meth)acrylate, caprolactone-modified dicyclopentenyl di(meth)acrylate, ethylene oxide-modified phosphoric acid di(meth)acrylate, di(acryloxyethyl) isocyanurate, allylated cyclohexyl di(meth)acrylate, ethoxylated bisphenol A diacrylate, and 9,9-bis[4-(2-acryloyloxyethoxy) phenyl] fluorene; trifunctional ones such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl) isocyanurate, and ε-caprolactone-modified tris-(2-(meth)acryloxyethyl) isocyanurate; tetrafunctional ones such as diglycerin tetra(meth)acrylate and pentaerythritol tetra(meth)acrylate; pentafunctional ones such as propionic acid-modified dipentaerythritol penta(meth)acrylate; and hexafunctional ones such as dipentaerythritol hexa(meth)acrylate and caprolactone-modified dipentaerythritol hexa(meth)acrylate. These may each be used alone or two or more types may also be used in combination. From the viewpoint of compatibility with the (meth)acrylic ester polymer (A), the polyfunctional acrylate-based monomer may preferably have a molecular weight of less than 1,000.

Among the above, from the viewpoint of the durability of the obtained pressure sensitive adhesive, preferred one may be a polyfunctional acrylate-based monomer containing an isocyanurate structure in the molecule, such as di(acryloxyethyl) isocyanurate, tris(acryloxyethyl) isocyanurate, or ε-caprolactone-modified tris-(2-(meth)acryloxyethyl) isocyanurate or a polyfunctional acrylate-based monomer containing a cyclic structure (especially cycloalkane structures) in the molecule, such as tricyclodecanedimethanol (meth)acrylate, more preferred one may be a trifunctional or higher polyfunctional acrylate-based monomer containing an isocyanurate structure in the molecule or a difunctional or higher polyfunctional acrylate-based monomer containing a polycyclic structure (especially cycloalkane polycyclic structure) in the molecule, particularly preferred one may be ε-caprolactone-modified tris-(2-(meth)acryloxyethyl) isocyanurate or tricyclodecanedimethanol (meth)acrylate, further preferred one may be ε-caprolactone-modified tris-(2-acryloxyethyl) isocyanurate or tricyclodecanedimethanol acrylate, and most preferred one may be ε-caprolactone-modified tris-(2-acryloxyethyl) isocyanurate.

The content of the active energy ray curable component (E) in the pressure sensitive adhesive composition P may be preferably 1 mass part or more, particularly preferably 3 mass parts or more, and further preferably 4 mass parts or more as the lower limit with respect to 100 mass parts of the (meth)acrylic ester polymer (A) from the viewpoints that the pressure sensitive adhesive after being cured with active energy rays can have suitable values such as gel fraction and storage elastic modulus and can be more excellent in the step followability under high-temperature and high-humidity conditions. On the other hand, from the viewpoint of the adhesive force of the pressure sensitive adhesive after being cured with active energy rays, the above content may be preferably 20 mass parts or less, particularly preferably 12 mass parts or less, and further preferably 8 mass parts or less as the upper limit.

### (1-6) Photopolymerization Initiator (F)

When ultraviolet rays are used as the active energy rays for curing the pressure sensitive adhesive composition P, the pressure sensitive adhesive composition P may preferably further contain a photopolymerization initiator (F). By containing the photopolymerization initiator (F) in this way, the active energy ray curable component (E) can be efficiently polymerized, and the polymerization curing time and the irradiation amount of the active energy rays can be reduced.

Examples of such a photopolymerization initiator (F) include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoate, oligo[2-hydroxy-2-methyl-1[4-(1-methylvinyl)phenyl]propane], 2,4,6-trimethylbenzoyl-diphenyl-phosphine oxide, and bis(2,4,6-trimethylbenzoyl)-phenylphosphine oxide. These may each be used alone or two or more types may also be used in combination.

Among the above, phosphine oxide-based photopolymerization initiators may be preferred because they are readily cleaved and can readily and reliably cure the pressure sensitive adhesive even when irradiated with ultraviolet rays through a rigid plate containing an ultraviolet absorber. Specifically, 2,4,6-trimethylbenzoyl-diphenyl-phosphine oxide, and bis(2,4,6-trimethylbenzoyl)-phenylphosphine oxide, etc. may be preferred.

The content of the photopolymerization initiator (F) in the pressure sensitive adhesive composition P may be preferably 0.1 mass parts or more, particularly preferably 1 mass part or more, and further preferably 5 mass parts or more as the lower limit with respect to 100 mass parts of the active energy ray curable component (E). From another aspect, the content may be preferably 30 mass parts or less, particularly preferably 20 mass parts or less, and further preferably 12 mass parts or less as the lower limit.

### (1-7) Various Additives

If desired, the pressure sensitive adhesive composition P can contain one or more of various additives, such as a silane coupling agent, an ultraviolet absorber, an antirust, an antistatic, a tackifier, an antioxidant, a light stabilizer, a softening agent, and a refractive index adjuster, which are commonly used in acrylic-based pressure sensitive adhesives. The additives which constitute the pressure sensitive adhesive composition P are deemed not to include a polymerization solvent or a diluent solvent, which will be described later.

The pressure sensitive adhesive composition P may preferably contain a silane coupling agent among the above. This can improve the interfacial adhesion with an adherend even when the adherend is a plastic plate or a glass member, and the step followability and the blister resistance under high-temperature and high-humidity conditions can be more excellent.

The silane coupling agent may be preferably an organosilicon compound having at least one alkoxysilyl group in the molecule, which has satisfactory compatibility with the (meth)acrylic ester polymer (A) and light transmittance.

Examples of such a silane coupling agent include polymerizable unsaturated group-containing silicon compounds such as vinyltrimethoxysilane, vinyltriethoxysilane and methacryloxypropyltrimethoxysilane, silicon compounds having an epoxy structure, such as 3-glycidoxypropyltrimethoxysilane and 2-(3,4-epoxycyclohexyl) ethyltrimethoxysilane, mercapto group-containing silicon compounds such as 3-mercaptopropyltrimethoxysilane, 3-mercaptopropyltriethoxysilane and 3-mercaptopropyldimethoxymethylsilane, amino group-containing silicon compounds such as 3-aminopropyltrimethoxysilane, N-(2-aminoethyl)-3-aminopropyltrimethoxysilane and N-(2-aminoethyl)-3-aminopropylmethyldimethoxysilane, 3-chloropropyltrimethoxysilane, 3-isocyanatepropyltriethoxysilane, and condensates of at least one of these and an alkyl group-containing silicon compound such as methyltriethoxysilane, ethyltriethoxysilane, methyltrimethoxysilane and ethyltrimethoxysilane. These may each be used alone or two or more types may also be used in combination.

The content of the silane coupling agent in the pressure sensitive adhesive composition P may be preferably 0.01 mass parts or more, particularly preferably 0.1 mass parts or more, and further preferably 0.2 mass parts or more with respect to 100 mass parts of the (meth)acrylic ester polymer (A). From another aspect, the content may be preferably 1.2 mass parts or less, particularly preferably 0.8 mass part or less, and further preferably 0.4 mass parts or less.

The pressure sensitive adhesive composition P may preferably contain an ultraviolet ray absorber. Examples of the ultraviolet ray absorber include compounds such as benzophenone-based, benzotriazole-based, benzoate-based, benzoxazinone-based, triazine-based, phenyl salicylate-based, cyanoacrylate-based, and nickel complex salt-based compounds, among which at least one of the benzophenone-based compound, the benzotriazole-based compound, and the triazine-based compound may be preferably used. These may each be used alone or two or more types may also be used in combination.

The content of the ultraviolet absorber in the pressure sensitive adhesive composition P may be preferably 1 mass part or more, particularly preferably 2 mass parts or more, and further preferably 3 mass parts or more with respect to 100 mass parts the (meth)acrylic ester polymer (A). From another aspect, the content may be preferably 20 mass parts or less, particularly preferably 10 mass parts or less, and further preferably 5 mass parts or less.

### (2) Preparation of Pressure Sensitive Adhesive Composition

The pressure sensitive adhesive composition P can be prepared through producing the (meth)acrylic ester polymer (A) and mixing the obtained (meth)acrylic ester polymer (A) and the crosslinker (B), and, if desired, adding the active energy ray curable component (E), the photopolymerization initiator (F), other additives, etc. In the case of the optically functional pressure sensitive adhesive layer 112, the colorant (C) or the light-diffusing fine particles (D) may be further compounded.

The (meth)acrylic ester polymer (A) can be produced by polymerizing a mixture of the monomers which constitute the polymer using a commonly-used radical polymerization method. Polymerization of the (meth)acrylic ester polymer (A) may be preferably carried out by a solution polymerization method, if desired, using a polymerization initiator. However, the present invention is not limited to this, and the polymerization may be performed without a solvent. Examples of the polymerization solvent include ethyl acetate, n-butyl acetate, isobutyl acetate, toluene, acetone, hexane, and methyl ethyl ketone, and two or more types thereof may also be used in combination.

Examples of the polymerization initiator include azo-based compounds and organic peroxides and two or more types thereof may also be used in combination. Examples of the azo-based compounds include 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxides include benzoyl peroxide, t-butyl perbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxybivalate, (3,5,5-trimethylhexanoyl) peroxide, dipropionyl peroxide, and diacetyl peroxide.

In the above polymerization step, the weight-average molecular weight of the polymer to be obtained can be adjusted by compounding a chain transfer agent such as 2-mercaptoethanol.

After the (meth)acrylic ester polymer (A) is obtained, the pressure sensitive adhesive composition P (coating solution) diluted with a solvent may be obtained through adding the crosslinker (B) and, if desired, a dilution solvent, the colorant (C) or the light-diffusing fine particles (D), the active energy ray curable component (E), the photopolymerization initiator (F), other additives, etc. to the solution of the (meth)acrylic ester polymer (A) and sufficiently mixing them. If any of the above components is in the form of a solid, or if precipitation occurs when the component is mixed with another component in an undiluted state, the component may be preliminarily dissolved in or diluted with a dilution solvent alone and then mixed with the other component.

Examples of the above dilution solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity falls within any range in which the coating is possible. For example, the pressure sensitive adhesive composition P may be diluted to a concentration of 10 to 60 mass %. When obtaining the coating solution, the addition of a dilution solvent or the like is not a necessary condition, and the dilution solvent may not be added if the pressure sensitive adhesive composition P has a viscosity or the like that enables the coating. In this case, the pressure sensitive adhesive composition P may be a coating solution in which the polymerization solvent itself for the (meth)acrylic ester polymer (A) is used as a dilution solvent.

### (3) Formation of Pressure Sensitive Adhesive Layer

The optically functional pressure sensitive adhesive layer 112 and transparent pressure sensitive adhesive layer 111 in the present embodiment may each be preferably composed of a pressure sensitive adhesive obtained by crosslinking the pressure sensitive adhesive composition P (a coating layer of the pressure sensitive adhesive composition P). Crosslinking of the pressure sensitive adhesive composition P can be ordinarily performed by heat treatment. Drying treatment when volatilizing a diluent solvent and the like from the coating layer of the pressure sensitive adhesive composition P applied to a desired object can also serve as the above heat treatment.

The heating temperature of the heat treatment may be preferably 50° C. to 150° C. and particularly preferably 70° C. to 120° C. The heating time may be preferably 10 seconds to 10 minutes and particularly preferably 50 seconds to 2 minutes.

After the heat treatment, if necessary, an aging period at an ordinary temperature (e.g., 23° C., 50% RH) for about 1 to 2 weeks may be provided. When the aging period is necessary, the pressure sensitive adhesive is formed after the aging period passes, while when the aging period is not necessary, the pressure sensitive adhesive is formed after the heat treatment.

The above heat treatment (and aging) allows the (meth)acrylic ester polymer (A) to be sufficiently crosslinked via the crosslinker (B).

The composite pressure sensitive adhesive layer 11 in the present embodiment can be obtained by laminating the optically functional pressure sensitive adhesive layer 112 and the transparent pressure sensitive adhesive layer 111. The timing of lamination may be before aging each pressure sensitive adhesive layer or after aging. However, in order to more enhance the interfacial adhesion between the optically functional pressure sensitive adhesive layer 112 and the transparent pressure sensitive adhesive layer 111, it may be preferred to laminate the pressure sensitive adhesive layers before aging them.

### (4) Physical Properties of Pressure Sensitive Adhesive

The gel fraction of the pressure sensitive adhesive for each of the optically functional pressure sensitive adhesive layer 112 and the transparent pressure sensitive adhesive layer 111 may be preferably 30% or more, more preferably 40% or more, particularly preferably 45% or more, and further preferably 50% or more as the lower limit. From another aspect, the gel fraction may be preferably 100% or less, more preferably 90% or less, particularly preferably 80% or less, further preferably 70% or less, and most preferably 65% or less as the upper limit. When the gel fraction of the pressure sensitive adhesive falls within the above range, the pressure sensitive adhesive exhibits good cohesive force, the step followability under high-temperature and high-humidity conditions can be excellent, and the occurrence of uneven optical function due to irregularities can readily be suppressed. Moreover, good adhesive strength is developed, and the adhesion property with an adherend can be more excellent. Here, the measurement method for the gel fraction of the pressure sensitive adhesive is as described in the Testing Example, which will be described later.

In the case of an active energy ray curable pressure sensitive adhesive, the gel fraction of the pressure sensitive adhesive after being cured with active energy rays may be preferably 40% or more, more preferably 50% or more, particularly preferably 60% or more, and further preferably 65% or more as the lower limit. From another aspect, the gel fraction may be preferably 100% or less, more preferably 90% or less, particularly preferably 80% or less, and further preferably 75% or less as the upper limit. When the gel fraction of the pressure sensitive adhesive after being cured with active energy rays falls within the above range, the step followability under high-temperature and high-humidity conditions can be more excellent, and the occurrence of uneven optical function due to irregularities can readily be suppressed. Moreover, good adhesive strength is developed, and the adhesion property with an adherend can be more excellent.

### (5) Thickness of Pressure Sensitive Adhesive Layer

The thickness of the optically functional pressure sensitive adhesive layer 112 may be sufficient if it allows the desired optical functions to be obtained, but may ordinarily be preferably 5 μm or more, more preferably 20 μm or more, particularly preferably 40 μm or more, and further preferably 50 μm or more as the lower limit. When the lower limit of the thickness of the optically functional pressure sensitive adhesive layer 112 satisfies the above, the aforementioned straightforward transmittance of light rays having a wavelength of 550 nm can be readily satisfied, and the desired optical functions can be readily obtained.

From another aspect, the thickness of the optically functional pressure sensitive adhesive layer 112 may be preferably 200 μm or less, more preferably 150 μm or less, particularly preferably 100 μm or less, and further preferably 75 μm or less as the upper limit. When the upper limit of the thickness of the optically functional pressure sensitive adhesive layer 112 satisfies the above, the thickness of the composite pressure sensitive adhesive layer 11 can readily be suitable. The optically functional pressure sensitive adhesive layer 112 may be formed as a single layer or may also be formed by laminating a plurality of layers.

On the other hand, the thickness of the transparent pressure sensitive adhesive layer 111 may be preferably 10 μm or more, more preferably 30 μm or more, particularly preferably 40 μm or more, and further preferably 50 μm or more as the lower limit. When the lower limit of the thickness of the transparent pressure sensitive adhesive layer 111 satisfies the above, it is possible to effectively suppress the compression or deformation of the optically functional pressure sensitive adhesive layer 112 due to the irregularities, and accordingly the occurrence of the uneven optical function.

The thickness of the transparent pressure sensitive adhesive layer 111 may be preferably 300 μm or less, more preferably 200 μm or less, particularly preferably 100 μm or less, and further preferably 75 μm or less as the upper limit. When the upper limit of the thickness of the transparent pressure sensitive adhesive layer 111 satisfies the above, the thickness of the composite pressure sensitive adhesive layer 11 can readily be suitable. The transparent pressure sensitive adhesive layer 111 may be formed as a single layer or may also be formed by laminating a plurality of layers.

The thickness of the composite pressure sensitive adhesive layer 11 can be appropriately set in accordance with its application, but may ordinarily be preferably 50 μm or more, more preferably 80 μm or more, particularly preferably 100 μm or more, and further preferably 150 μm or more as the lower limit. When the lower limit of the composite pressure sensitive adhesive layer 11 satisfies the above, the desired adhesive strength and excellent step followability can readily be obtained.

The thickness of the composite pressure sensitive adhesive layer 11 may be preferably 500 μm or less, more preferably 300 μm or less, particularly preferably 250 μm or less, and further preferably 200 μm or less as the upper limit. When the upper limit of the thickness of the composite pressure sensitive adhesive layer 11 satisfies the above, workability can be good, and appearance failures such as due to impressions are less likely to occur.

### 1-2. Release Sheets

In the pressure sensitive adhesive sheet 1 according to the present embodiment, the first release sheet 12a may be laminated on the optically functional pressure sensitive adhesive layer 112, and the second release sheet 12b may be laminated on the transparent pressure sensitive adhesive layer 111. When the pressure sensitive adhesive sheet 1 is used, the first release sheet 12a may be removed first, and then the second release sheet 12b may be removed. The first release sheet 12a may therefore be preferably an easy release sheet that requires lower peeling force than that for the second release sheet 12b while the second release sheet 12b may be preferably a tight release sheet that requires higher peeling force than that for the first release sheet 12a.

In the pressure sensitive adhesive sheet 1 according to the present embodiment, the first release sheet 12a may not necessarily be required. When the first release sheet 12a is absent, the second release sheet 12b may not be a tight release sheet and may also be a film or flexible base material having uncontrolled peeling force.

Examples of the release sheets 12a and 12b for use include a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene vinyl acetate film, an ionomer resin film, an ethylene-(meth)acrylic acid copolymer film, an ethylene-(meth)acrylic ester copolymer film, a polystyrene film, a polycarbonate film, a polyimide film, and a fluorine resin film. Crosslinked films thereof may also be used. Laminate films each obtained by laminating a plurality of such films may also be used.

It may be preferred to perform release treatment for the release surfaces (in particular, surfaces to be in contact with the composite pressure sensitive adhesive layer 11) of the release sheets 12a and 12b. Examples of a release agent to be used for the release treatment include alkyd-based, silicone-based, fluorine-based, unsaturated polyester-based, polyolefin-based, and wax-based release agents.

By appropriately selecting the type of the above release agent, the peeling force can be controlled. That is, the first release sheet 12a can be an easy release sheet that requires lower peeling force than that for the second release sheet 12b, while the second release sheet 12b can be a tight release sheet that requires higher peeling force than that for the first release sheet 12a.

The thickness of the release sheets 12a and 12b is not particularly limited, but may be ordinarily about 20 to 200 μm.

### 2. Physical Properties

### (1) Adhesive Strength

The adhesive strength of the optically functional pressure sensitive adhesive layer 112 to soda-lime glass may be preferably 10 N/25 mm or more, more preferably 20 N/25 mm or more, particularly preferably 30 N/25 mm or more, and further preferably 40 N/25 mm or more as the lower limit. When the lower limit of the adhesive strength satisfies the above, the step followability under high-temperature and high-humidity conditions can be excellent. From another aspect, the adhesive strength of the optically functional pressure sensitive adhesive layer 112 to soda-lime glass may be preferably 90 N/25 mm or less, more preferably 70 N/25 mm or less, and particularly preferably 50 N/25 mm or less as the upper limit. When the upper limit of the adhesive strength satisfies the above, good reworkability can be obtained, and in the event of a lamination error, it is possible to reuse the display body structural members, especially expensive display body structural members.

When the pressure sensitive adhesive constituting the optically functional pressure sensitive adhesive layer 112 is an active energy ray curable pressure sensitive adhesive, the adhesive strength of the optically functional pressure sensitive adhesive layer 112 after being cured with active energy rays may be preferably 20 N/25 mm or more, particularly preferably 30 N/25 mm or more, and further preferably 40 N/25 mm or more as the lower limit. When the lower limit of the adhesive strength satisfies the above, the step followability under high-temperature and high-humidity conditions can be excellent. From another aspect, the adhesive strength of the optically functional pressure sensitive adhesive layer 112 after being cured with active energy rays to soda-lime glass may be preferably 100 N/25 mm or less, more preferably 75 N/25 mm or less, and particularly preferably 50 N/25 mm or less as the upper limit. When the adhesive strength satisfies the above, good reworkability can be obtained, and in the event of a lamination error, it is possible to reuse the display body structural members, especially expensive display body structural members.

The adhesive strength of the transparent pressure sensitive adhesive layer 111 to soda-lime glass may be preferably 10 N/25 mm or more, more preferably 20 N/25 mm or more, particularly preferably 30 N/25 mm or more, and further preferably 40 N/25 mm or more as the lower limit. When the lower limit of the adhesive strength satisfies the above, the step followability under high-temperature and high-humidity conditions can be excellent. From another aspect, the adhesive strength of the transparent pressure sensitive adhesive layer 111 to soda-lime glass may be preferably 90 N/25 mm or less, more preferably 70 N/25 mm or less, and particularly preferably 60 N/25 mm or less as the upper limit. When the upper limit of the adhesive strength satisfies the above, good reworkability can be obtained.

When the pressure sensitive adhesive constituting the transparent pressure sensitive adhesive layer 111 is an active energy ray curable pressure sensitive adhesive, the adhesive strength of the transparent pressure sensitive adhesive layer 111 after being cured with active energy rays to soda-lime glass may be preferably 30 N/25 mm or more, particularly preferably 40 N/25 mm or more, and further preferably 50 N/25 mm or more as the lower limit. When the lower limit of the adhesive strength satisfies the above, the step followability under high-temperature and high-humidity conditions can be excellent. From another aspect, the adhesive strength of the transparent pressure sensitive adhesive layer 111 after being cured with active energy rays to soda-lime glass may be preferably 100 N/25 mm or less, more preferably 75 N/25 mm or less, and particularly preferably 65 N/25 mm or less as the upper limit. When the upper limit of the adhesive strength satisfies the above, good reworkability can be obtained.

As used in the present specification, the adhesive strength refers basically to a peel strength that is measured using a method of 180° peeling according to JIS 20237: 2009. A measurement sample having a width of 25 mm and a length of 100 mm is used. The measurement sample is bonded to an adherend and pressurized at 0.5 MPa and 50° C. for 20 minutes. After that, the measurement sample is left untouched under a condition of 23° C. and 50% RH for 24 hours, and then the measurement is performed at a peel speed of 300 mm/min.

### (2) Step Following Ratio

The followability of the pressure sensitive adhesive layer to the irregularities of an adherend, or the step followability, can be determined using a step following ratio (%) as an indicator. The step following ratio (%) of the optically functional pressure sensitive adhesive layer 112, which is represented by the following equation, may be preferably 20% or more, particularly preferably 30% or more, and further preferably 40% or more as the lower limit. The upper limit of the above step following ratio is not particularly limited, but it may ordinarily be preferably 80% or less and particularly preferably 70% or less.

On the other hand, the step following ratio (%) of the transparent pressure sensitive adhesive layer 111 may be preferably 20% or more, particularly preferably 30% or more, and further preferably 40% or more as the lower limit. The upper limit of the above step following ratio is not particularly limited, but it may ordinarily be preferably 80% or less and particularly preferably 70% or less.

Step following ratio (%)={(Height (μm) of steps maintaining embedded state without air bubbles, floating, delamination, etc. after prescribed durability test)/(Thickness of pressure sensitive adhesive layer)1×100

The testing method for the step following ratio is as described in the Testing Example, which will be described later. In the case of an active energy ray curable pressure sensitive adhesive, the step following ratio is that when the measurement sample is bonded to an adherend and then cured with active energy rays.

### 3. Production of Pressure Sensitive Adhesive Sheet

An example of producing the pressure sensitive adhesive sheet 1 may include coating the release surface of the first release sheet 12a with a coating solution of the above pressure sensitive adhesive composition P for forming the optically functional pressure sensitive adhesive layer 112 and performing heat treatment to thermally crosslink the pressure sensitive adhesive composition P to form a coating layer, thus obtaining the release sheet 12a with the coating layer. The example may further include coating the release surface of the second release sheet 12b with a coating solution of the pressure sensitive adhesive composition P for forming the transparent pressure sensitive adhesive layer 111 and performing heat treatment to thermally crosslink the pressure sensitive adhesive composition P to form a coating layer, thus obtaining the release sheet 12b with the coating layer. Then, the release sheet 12a with the coating layer and the release sheet 12b with the coating layer are bonded so that both the coating layers are in contact with each other. When an aging period is necessary, the above laminated coating layers may become the composite pressure sensitive adhesive layer 11 after the aging period passes, while when an aging period is not necessary, the above laminated coating layers formed as such may be the composite pressure sensitive adhesive layer 11. The above pressure sensitive adhesive sheet 1 can thus be obtained, which is a laminate of the optically functional pressure sensitive adhesive layer 112 and the transparent pressure sensitive adhesive layer 111. Conditions for the heat treatment and aging are as previously described.

The coating layer for forming the transparent pressure sensitive adhesive layer 111 and the coating layer for forming the optically functional pressure sensitive adhesive layer 112 may each be interposed between two release sheets, and when the coating layer for forming the transparent pressure sensitive adhesive layer 111 and the coating layer for forming the optically functional pressure sensitive adhesive layer 112 are bonded together, one release sheet may be removed from each of the coating layers.

Examples of the method of coating with the above coating solution of the pressure sensitive adhesive composition P include a bar coating method, a knife coating method, a roll coating method, a blade coating method, a die coating method, and a gravure coating method.

### <Structure>

The structure according to an embodiment of the present invention is obtained by bonding two rigid plates together with a composite pressure sensitive adhesive layer (preferably the composite pressure sensitive adhesive layer of the pressure sensitive adhesive sheet according to the aforementioned embodiment) comprising an optically functional pressure sensitive adhesive layer and a transparent pressure sensitive adhesive layer that does not have the optical function of the optically functional pressure sensitive adhesive layer. The composite pressure sensitive adhesive layer has a straightforward transmittance of 90% or less for light rays having a wavelength of 550 nm. At least one of the two rigid plates has irregularities on the surface on the side to be bonded to the other rigid plate. The structure can be obtained through bonding the optically functional pressure sensitive adhesive layer of the above composite pressure sensitive adhesive layer to either one of the above two rigid plates, then removing a release sheet from the transparent pressure sensitive adhesive layer of the composite pressure sensitive adhesive layer, and bonding the exposed transparent pressure sensitive adhesive layer and the other of the above two rigid plates together. The details of the above composite pressure sensitive adhesive layer are as described for the aforementioned pressure sensitive adhesive sheet.

As used in the present specification, the term “rigid body” refers to a member whose bendable angle is less than 90° without irreversibly deforming the structure. The angle may be preferably less than 60°, more preferably less than 45°, particularly preferably less than 10°, and further preferably less than 5°. The bendable angle (bending angle) refers to an angle formed between a rigid body and a horizontal surface when the rigid body is placed on the horizontal surface, one end portion is fixed, and the other end portion is raised from the horizontal surface. The rigid body may be composed of a single layer or a single member or may also be composed of two or more layers or two or more members. In the latter case, when an object composed of two or more layers or two or more members is used upon bonding to the composite pressure sensitive adhesive layer, that object as a whole satisfying the above bending angle is referred to as a rigid body, and even when some of the layers or members of the object do not satisfy the above bending angle, that object can be referred to as a rigid body.

Both the above two rigid plates may be preferably display body structural members. The structure according to the present embodiment may be a display body itself or may also be a member that constitutes a part of the display body. Moreover, the present invention is not limited to these, and the structure may be used for optical applications other than display bodies.

Examples of the above display (display) include display bodies for in-vehicle use such as those of various meters provided on instrument panels, car navigation systems, and consoles of automobiles, display bodies such as those of smartphones and tablet terminals for general users, display bodies such as those of tablet terminals and digital signage for commercial use, and display bodies such as those of outdoor digital signage. Examples of the types of the above display body include liquid crystal (LCD) displays, light emitting diode (LED) displays, organic electroluminescence (organic EL) displays, and electronic paper. The display body may be a touch panel.

The above irregularities may be preferably those due to a printed layer (steps due to printing). However, the above irregularities may be those other than the irregularities due to the printed layer. Examples of irregularities include those possessed by a rigid plate itself, those provided on a rigid plate by a method other than printing (those due to the pressure sensitive adhesive sheet, those formed by directly applying/curing a liquid adhesive, etc.), and those due to a decorative layer representing letters and symbols.

FIG. 2 illustrates a specific configuration of the structure according to an embodiment of the present invention. As illustrated in FIG. 2, a structure 2A according to the present embodiment may be configure to include a first display body structural member 21, a second display body structural member 22, and a composite pressure sensitive adhesive layer 11 that is located between the first display body structural member 21 and the second display body structural member 22 and bonds them together.

At least one of the first display body structural member 21 and the second display body structural member 22 may have irregularities on the surface on the side to be bonded by the composite pressure sensitive adhesive layer 11. In the embodiment illustrated in FIG. 2, the first display body structural member 21 has irregularities due to a printed layer 23 on the surface on the composite pressure sensitive adhesive layer 11 side.

The composite pressure sensitive adhesive layer 11 in the above structure 2A may be preferably the composite pressure sensitive adhesive layer 11 of the aforementioned pressure sensitive adhesive sheet 1. The composite pressure sensitive adhesive layer 11 in the present embodiment is a laminate of the optically functional pressure sensitive adhesive layer 112 and the transparent pressure sensitive adhesive layer 111, and the optically functional pressure sensitive adhesive layer 112 is located on the side in contact with the first display body structural member 21 while the transparent pressure sensitive adhesive layer 111 is located on the side in contact with the second display body structural member 22. In the present embodiment, therefore, the optically functional pressure sensitive adhesive layer 112 is in contact with the irregularities due to the printed layer 23.

The first display body structural member 21 may be preferably a protective panel composed of a glass plate, a plastic plate, a laminate including them, etc. In this case, the printed layer 23 may be generally formed in a frame shape on the composite pressure sensitive adhesive layer 11 in the first display body structural member 21.

The above glass plate is not particularly limited, and examples thereof include chemically strengthened glass, non-alkali glass, quartz glass, soda lime glass, barium/strontium-containing glass, aluminosilicate glass, lead glass, borosilicate glass, and barium borosilicate glass. Although the thickness of the glass plate is not particularly limited, it may be ordinarily 0.1 to 5 mm and preferably 0.2 to 2 mm.

The above plastic plate is not particularly limited, and examples thereof include an acrylic plate and a polycarbonate plate. Although the thickness of the plastic plate is not particularly limited, it may be ordinarily 0.2 to 5 mm and preferably 0.4 to 3 mm.

One surface or both surfaces of the above glass plate or plastic plate may be provided with various functional layers (such as a transparent conductive film, a metal layer, a silica layer, a hard coat layer, and an antiglare layer), or one or more optical members may be laminated on one surface or both surfaces of the above glass plate or plastic plate. The transparent conductive film and the metal layer may be patterned.

The second display body structural member 22 may be preferably an optical member, a display body module (e.g., a liquid crystal (LCD) module, a light emitting diode (LED) module, an organic electroluminescence (organic EL) module, etc.), an optical member as part of a display body module, or a laminate including a display body module.

Examples of the above optical member include anti-scattering films, polarizing plates (polarizing films), polarizers, retardation plates (retardation films), viewing angle compensation films, brightness enhancement films, contrast enhancement films, liquid crystal polymer films, diffusion films, semi-transmissive reflective films, and transparent conductive films. Examples of the anti-scattering film include a hard coat film configured such that a hard coat layer is formed on one surface of a base material film.

The material constituting the printed layer 23 is not particularly limited, and known materials for printing may be used. The lower limit of the thickness of the printed layer 23, that is, the height of the step or steps, may be preferably 3 μm or more, more preferably 5 μm or more, particularly preferably 7 μm or more, and most preferably 10 μm or more. When the lower limit satisfies the above, it is possible to sufficiently ensure shielding properties such as making the electric wiring invisible from the viewer side. The upper limit may be preferably 50 μm or less, more preferably 35 μm or less, particularly preferably 25 μm or less, and further preferably 20 μm or less. When the upper limit satisfies the above, it is possible to prevent deterioration of the step followability of the composite pressure sensitive adhesive layer 11 with respect to the printed layer 23 and suppress uneven optical function.

To manufacture the above structure 2A, as an example, the first release sheet 12a of the pressure sensitive adhesive sheet 1 may be removed, and the exposed optically functional pressure sensitive adhesive layer 112 of the pressure sensitive adhesive sheet 1 may be bonded to the surface of the first display body structural member 21 on the side on which the printed layer 23 is present. Then, the second release sheet 12b may be removed from the composite pressure sensitive adhesive layer 11 of the pressure sensitive adhesive sheet 1, and the exposed transparent pressure sensitive adhesive layer 111 of the pressure sensitive adhesive sheet 1 and the second display body structural member 22 may be bonded together.

When the composite pressure sensitive adhesive layer 11 (the optically functional pressure sensitive adhesive layer 112 and/or the transparent pressure sensitive adhesive layer 111) is active energy curable, after the first display body structural member 21 and the second display body structural member 22 are bonded together via the composite pressure sensitive adhesive layer 11 as described above, the composite pressure sensitive adhesive layer 11 may be irradiated with active energy rays. This allows the active energy ray curable component (E) in the composite pressure sensitive adhesive layer 11 to be polymerized to cure the composite pressure sensitive adhesive layer 11. Irradiation with energy rays for the composite pressure sensitive adhesive layer 11 may be ordinarily performed through either the first display body structural member 21 or the second display body structural member 22, and preferably performed through the first display body structural member 21 as a protection panel.

The active energy rays refer to electromagnetic waves or charged particle radiation having an energy quantum, and specific examples of the active energy rays include ultraviolet rays and electron rays. Among the active energy rays, ultraviolet rays may be particularly preferred because of easy management.

The irradiation with ultraviolet rays can be performed by using a high-pressure mercury lamp, a fusion H lamp, a xenon lamp, or the like. The amount of irradiation with ultraviolet rays, or the illuminance, may be preferably about 50 to 1,000 mW/cm² in an embodiment or preferably about 100 to 500 mW/cm² in another embodiment. The amount of light may be preferably 50 to 10,000 mJ/cm², more preferably 200 to 7,000 mJ/cm², and particularly preferably 500 to 3,000 mJ/cm². On the other hand, the irradiation with electron rays can be performed by using an electron ray accelerator or the like, and the amount of irradiation with electron rays may be preferably about 10 to 10,000 krad.

By manufacturing the structure 2A as described above, when the optical functional pressure sensitive adhesive layer 112 is bonded to the first display body structural member 21, the pressure sensitive adhesive sheet 1 can be bonded while being bent, and the deformation of the optically functional pressure sensitive adhesive layer 112 can therefore be suppressed. Moreover, when the transparent pressure sensitive adhesive layer 111 is bonded to the second display body structural member 22, the transparent pressure sensitive adhesive layer 111, which is liable to be stressed, absorbs deformation and is less likely to affect the optically functional pressure sensitive adhesive layer 112, and it is thus possible to suppress the uneven optical function in the composite pressure sensitive adhesive layer 11.

FIG. 3 illustrates a specific configuration of the structure according to another embodiment of the present invention. As illustrated in FIG. 3, a structure 2B according to the present embodiment may be configure to include a first display body structural member 21, a second display body structural member 22, and a composite pressure sensitive adhesive layer 11 (a laminate of a transparent pressure sensitive adhesive layer 111 and a optically functional pressure sensitive adhesive layer 112) that is located between the first display body structural member 21 and the second display body structural member 22 and bonds them together.

The first display body structural member 21, the second display body structural member 22, and the composite pressure sensitive adhesive layer 11 are the same as those in the structure 2A according to the aforementioned embodiment. In the structure 2B according to the present embodiment, however, the transparent pressure sensitive adhesive layer 111 is located on the side in contact with the first display body structural member 21 while the optically functional pressure sensitive adhesive layer 112 is located on the side in contact with the second display body structural member 22. In the present embodiment, therefore, the transparent pressure sensitive adhesive layer 111 is in contact with the irregularities due to the printed layer 23.

To manufacture the above structure 2B, as an example, the first release sheet 12a of the pressure sensitive adhesive sheet 1 may be removed, and the exposed optically functional pressure sensitive adhesive layer 112 of the pressure sensitive adhesive sheet 1 may be bonded to the second display body structural member 22. Then, the second release sheet 12b may be removed from the composite pressure sensitive adhesive layer 11 of the pressure sensitive adhesive sheet 1, and the exposed transparent pressure sensitive adhesive layer 111 of the pressure sensitive adhesive sheet 1 and the surface of the first display body structural member 21 on the side on which the printed layer 23 is present may be bonded together.

When the composite pressure sensitive adhesive layer 11 (the optically functional pressure sensitive adhesive layer 112 and/or the composite pressure sensitive adhesive layer 11) is active energy curable, the structure 2B may be irradiated with active energy rays in the same manner as for the structure 2A according to the aforementioned embodiment.

By manufacturing the structure 2B as described above, the optical functional pressure sensitive adhesive layer 112 may be well bonded to the second display body structural member 22 without deformation. Then, the transparent pressure sensitive adhesive layer 111 from which the second release sheet 12b is removed may be bonded to the first display body structural member 21 having irregularities. In this operation, the pressure sensitive adhesive sheet 1 according to the present embodiment may be deformed due to the irregularities, but the transparent pressure sensitive adhesive layer 111 may absorb the deformation due to the irregularities, which does not affect the optically functional pressure sensitive adhesive layer 112, and it is thus possible to suppress the uneven optical function in the composite pressure sensitive adhesive layer 11.

In the above structure 2A, 2B, when the composite pressure sensitive adhesive layer 11 is formed of the pressure sensitive adhesive composition P, the composite pressure sensitive adhesive layer 11 is excellent in the step followability under high-temperature and high-humidity conditions; therefore, even when the structure 2A, 2B is placed under high-temperature and high-humidity conditions (e.g., 85° C.,, 85% RH), the occurrence of air bubbles, floating, delamination, etc. near the steps can be suppressed.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, the first release sheet 12a in the pressure sensitive adhesive sheet 1 may be omitted. Additionally or alternatively, in the structure 2A, 2B, both the first display body structural member and the second display body structural member have irregularities on the composite pressure sensitive adhesive layer 11 sides.

### EXAMPLES

Hereinafter, the present invention will be described further specifically with reference to examples, etc., but the scope of the present invention is not limited to these examples, etc.

### <Production Example 1> (Preparation of Optically Functional (Coloring) Pressure Sensitive Adhesive Layer)

### 1. Preparation of (Meth)acrylic Ester Polymer

The (meth)acrylic ester polymer (A) was prepared by using a solution polymerization method to copolymerize 45 mass parts of 2-ethylhexyl acrylate, 20 mass parts of n-butyl acrylate, 10 mass parts of isobornyl acrylate, 5 mass parts of N-acryloylmorpholine, and 20 mass parts of 2-hydroxyethyl acrylate. The molecular weight of the (meth)acrylic ester polymer (A) was measured by the method, which will be described later. The weight-average molecular weight (Mw) was 600,000.

### 2. Preparation of Pressure Sensitive Adhesive Composition

The coating solution of a pressure sensitive adhesive composition was obtained through mixing and sufficiently stirring 100 mass parts (solid content equivalent, here and hereinafter) of the (meth)acrylic ester polymer (A) obtained in the above step 1, 0.2 mass parts of trimethylol propane-modified tolylene diisocyanate (available from TOYOCHEM CO., LTD., product name “BHS8515”) as the crosslinker (B), 0.6 mass parts of a carbon black-based black pigment (C1) as the colorant (C), 5.0 mass parts of ε-caprolactone-modified tris-(2-acryloxyethyl) isocyanurate (available from SHIN-NAKAMURA CHEMICAL Co., Ltd., product name “NK Ester A-9300-1CL”) as the active energy ray curable component (E), 0.5 mass parts of 2,4,6-trimethylbenzoyl-diphenyl-phosphine oxide as the photopolymerization initiator (F), and 0.3 mass parts of 3-glycidoxypropyltrimethoxysilane as the silane coupling agent and diluting the mixture with methyl ethyl ketone.

Here, Table 1 lists the formulations (solid content equivalents) of the pressure sensitive adhesive compositions when the (meth)acrylic ester polymer (A) is 100 mass parts (solid content equivalent). Details of the simplified names listed in Table 1 and additional information are as follows.

«(Meth)acrylic ester polymer (A)»
2EHA: 2-ethylhexyl acrylate
BA: n-butyl acrylate
MMA: methyl methacrylate
IBXA: isobornyl acrylate
ACMO: N-acryloylmorpholine
HEA: 2-hydroxyethyl acrylate
AA: Acrylic acid

### «Colorant (C)»

C1: carbon black-based black pigment having physical properties listed in Table 2

### 3. Production of Optically Functional Pressure Sensitive Adhesive Sheet

The release-treated surface of a first easy release sheet (available from LINTEC Corporation, product name “SP-PET752150”) was coated with the coating solution of the pressure sensitive adhesive composition obtained in the above step 2 by using a knife coater, and heat treatment was performed at 90° C. for 1 minute to form a coating layer (thickness: 50 μm). In the first easy release sheet, one surface of a polyethylene terephthalate film was subjected to release treatment with a silicone-based release agent.

Subsequently, the coating layer on the first easy release sheet obtained as above and a second easy release sheet (available from LINTEC Corporation, product name “SP-PET381031”) obtained by release-treating one surface of a polyethylene terephthalate film with a silicone-based release agent were bonded to each other so that the release-treated surface of the second easy release sheet was in contact with the coating layer, and a optically functional pressure sensitive adhesive sheet was thus prepared, having a configuration of first easy release sheet/optically functional pressure sensitive adhesive layer (a) (thickness: 50 μm)/second easy release sheet. The optical function of the optically functional pressure sensitive adhesive layer

(a) is coloring.

The thickness of the above optically functional pressure sensitive adhesive layer is a value measured according to JIS K7130 using a constant-pressure thickness meter (available from TECLOCK Co., Ltd., product name “PG-02”) (here and hereinafter).

### <Production Example 2> (Preparation of Optically Functional (Light-diffusing) Pressure Sensitive Adhesive Layer)

The coating solution of a pressure sensitive adhesive composition was obtained through mixing and sufficiently stirring 100 mass parts of the (meth)acrylic ester polymer (A) prepared in the same manner as in Production Example 1, 0.3 mass parts of trimethylol propane-modified tolylene diisocyanate (available from TOYOCHEM CO., LTD., product name “BHS8515”) as the crosslinker (B), 5.0 mass parts of fine particles (“Tospearl 145” available from Momentive Performance Materials Japan, average particle diameter: 4.5 μm) composed of a silicone resin (silicon-containing compound having an intermediate structure between inorganic one and organic one) as the light-diffusing fine particles (D), 5.0 mass parts of ε-caprolactone-modified tris-(2-acryloxyethyl) isocyanurate (available from SHIN-NAKAMURA CHEMICAL Co., Ltd., product name “NK Ester A-9300-1CL”) as the active energy ray curable component (E), 0.5 mass parts of 2,4,6-trimethylbenzoyl-diphenyl-phosphine oxide as the photopolymerization initiator (F), and 0.3 mass parts of 3-glycidoxypropyltrimethoxysilane as the silane coupling agent and diluting the mixture with methyl ethyl ketone.

An optically functional pressure sensitive adhesive sheet having an optically functional pressure sensitive adhesive layer (b) was prepared in the same manner as in Production Example 1 using the obtained coating solution of the pressure sensitive adhesive composition. The optical function of the optically functional pressure sensitive adhesive layer (b) is light diffusion.

### <Production Examples 3 to 5> (Preparation of Transparent Pressure Sensitive Adhesive Sheets)

Transparent pressure sensitive adhesive sheets having a transparent pressure sensitive adhesive layer (c) (Production Example 3), a transparent pressure sensitive adhesive layer (d) (Production Example 4), and a transparent pressure sensitive adhesive layer (e) (Production Example 5) were prepared in the same manner as in Example 1 except that the types and ratio of monomers constituting the (meth)acrylic ester polymer (A), the weight-average molecular weight (Mw) of the (meth)acrylic ester polymer (A), the compounding amount of the crosslinker (B), the compounding amount of the colorant (C) (not compounded), the compounding amount of the light-diffusing fine particles (D) (not compounded), the compounding amount of the active energy ray curable component (E), the compounding amount of the photopolymerization initiator (F), the compounding amount of the silane coupling agent, the compounding amount of ultraviolet absorber (available from BASF, product name “Tinuvin 384-2”), and the thickness of the pressure sensitive adhesive layer were as listed in Table 1. However, a tight release sheet (available from LINTEC Corporation, product name “SP-PET752150”) was used instead of the first easy release sheet in Production Example 1, and the second easy release sheet was used as an easy release sheet.

The transparent pressure sensitive adhesive layer (c) and the transparent pressure sensitive adhesive layer (e) prepared in Production Example 3 and Production Example 5 are each composed of an active energy ray non-curable pressure sensitive adhesive, and the transparent pressure sensitive adhesive layer (d) prepared in Production Example 4 is composed of an active energy ray curable pressure sensitive adhesive.

The aforementioned weight-average molecular weight (Mw) refers to a weight-average molecular weight that is measured as a polystyrene equivalent value under the following condition using gel permeation chromatography (GPC) (GPC measurement).

### «Measurement Condition»

GPC measurement device: HLC-8020 available from Tosoh Corporation
GPC columns (passing through in the following order): available from Tosoh Corporation
   TSK guard column HXL-H
   TSK gel GMHXL (x2)
   TSK gel G2000HXL
Solvent for measurement: tetrahydrofuran
Measurement temperature: 40° C.

### Example 1

The second easy release sheet was removed from the optically functional pressure sensitive adhesive layer prepared in Production Example 1 to expose the optically functional pressure sensitive adhesive layer (a). Likewise, the easy release sheet was removed from the transparent pressure sensitive adhesive sheet prepared in Production Example 3 to expose the transparent pressure sensitive adhesive layer (c). Then, the exposed optically functional pressure sensitive adhesive layer (a) and transparent pressure sensitive adhesive layer (c) were laminated. After that, they were aged for 7 days under a condition of 23° ^{C}. and 50% RH.

A pressure sensitive adhesive sheet was thus produced, having a configuration of first easy release sheet/optically functional pressure sensitive adhesive layer (a) (first layer; 50 μm)/transparent pressure sensitive adhesive layer (c) (second layer; 50 μm)/tight release sheet. The first layer is a layer to be bonded to an adherend first while the second layer is a layer to be bonded to the adherend later. The optically functional pressure sensitive adhesive layer (a) and the transparent pressure sensitive adhesive layer (c) are collectively referred to as a composite pressure sensitive adhesive layer.

### Examples 2 to 6 and Comparative Examples 1 to 3

Pressure sensitive adhesive sheets were produced in the same manner as in Example 1 except that the pressure sensitive adhesive layers of the first layer and second layer were as listed in Table 3.

### 10<Testing Example 1> (Measurement of Gel Fraction)

The pressure sensitive adhesive sheet prepared in each of Production Example was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 24 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the mesh itself. The mass at that time is M2. The gel fraction (%) is represented by (M2/M1)×100. Through this operation, the gel fraction of the pressure sensitive adhesive (before UV) was derived. The results are listed in Table 3.

In addition, the pressure sensitive adhesive layer of the pressure sensitive adhesive sheet prepared in each of Production Examples 1, 2, and 4 was irradiated with active energy rays (ultraviolet rays; UV) under the following condition through the second easy release sheet or the easy release sheet to cure the pressure sensitive adhesive layer, thus obtaining a cured pressure sensitive adhesive layer. For the pressure sensitive adhesive of the cured pressure sensitive adhesive layer, the gel fraction (after UV) was derived. The results are listed in Table 3.

### «Active Energy Ray Irradiation Condition»

Using a high-pressure mercury lamp
Illuminance of 200 mW/cm² and light amount of 2,000 mJ/cm²
Using “UVPF-A1” available from EYE GRAPHICS CO., LTD. as a UV illuminance/light amount meter

### <Testing Example 2> (Measurement of Storage Elastic Modulus)

The release sheet was removed from the pressure sensitive adhesive sheet prepared in each of Production Examples, and a plurality of pressure sensitive adhesive layers were laminated to have a thickness of 3 mm. A cylindrical body (height of 3 mm) having a diameter of 8 mm was punched out from the obtained laminate of the pressure sensitive adhesive layers, and this was used as a sample.

For the above sample, the storage elastic modulus (before UV; MPa) at 23° C. was measured by a torsional shear method according to JIS K7244-6 using a viscoelasticity measurement device (available from Physica, product name “MCR300”) under the following condition. The results are listed in Table 3.
Measurement frequency: 1 Hz
Measurement temperature: 23° C.

In addition, for the pressure sensitive adhesive sheet prepared in each of Production Examples 1, 2, and 4, the same sample as above was irradiated with active energy rays (ultraviolet rays; UV) under the same condition as in Testing Example 1 to cure the pressure sensitive adhesive, thereby obtaining a sample after irradiation with active energy rays. The storage elastic modulus (after UV; MPa) at 23° C. of the obtained sample after irradiation with active energy rays was measured in the same manner as for the sample before irradiation with active energy rays. The results are listed in Table 3.

### <Testing Example 3> (Measurement of Total Luminous Transmittance)

The pressure sensitive adhesive layer of the pressure sensitive adhesive sheet prepared in each of Production Examples was bonded to glass, and this was used as a sample for measurement. After performing background measurement on the glass, the total luminous transmittance (%) of the above sample for measurement was measured according to JIS K7361-1: 1997 using a haze meter (available from NIPPON DENSHOKU INDUSTRIES CO., LTD., product name “SH-7000”). The results are listed in Table 3.

For the pressure sensitive adhesive sheet produced in each of Examples and Comparative Examples, the surface on the second layer side was bonded to glass, and the total luminous transmittance (%) was measured in the same manner as above. The pressure sensitive adhesive sheets produced in Examples and Comparative Examples other than Comparative Example 1 were irradiated with active energy rays under the same condition as in Testing Example 1 to cure the active energy ray curable pressure sensitive adhesives, and then the above measurement was performed. The results are listed in Table 4.

### 5<Testing Example 4> (Measurement of Haze Value)

For the pressure sensitive adhesive layer of the pressure sensitive adhesive sheet prepared in each of Production Examples, the haze value (%) was measured according to JIS K7136: 2000 using a haze meter (available from NIPPON DENSHOKU INDUSTRIES CO., LTD., product name “SH-7000”). The results are listed in Tables 3 and 4.

For the pressure sensitive adhesive layer of the pressure sensitive adhesive sheet produced in each of Examples and Comparative Examples, the haze value (%) was measured in the same manner as above. The pressure sensitive adhesive sheets produced in Examples and Comparative Examples other than Comparative Example 1 were irradiated with active energy rays under the same condition as in Testing Example 1 to cure the active energy ray curable pressure sensitive adhesives, and then the above measurement was performed. The results are listed in Table 4.

### <Testing Example 5> (Measurement of Straightforward Transmittance)

For the pressure sensitive adhesive layer of the pressure sensitive adhesive sheet prepared in each of Examples, the total transmittance (%) and diffuse transmittance (%) of the transmitted light components were measured at 1 nm-pitch wavelengths within a wavelength region of 380 nm to 780 nm using an ultraviolet/visible near-infrared spectrophotometer (available from Shimadzu Corporation, product name “UV-3600”), and the total transmittance at a wavelength of 550 nm and the diffuse transmittance of light rays at a wavelength of 550 nm were obtained. Then, the straightforward transmittance (%) of light rays having a wavelength of 550 nm was calculated by subtracting the diffuse transmittance from the obtained total transmittance. The results are listed in Table 3.

For the pressure sensitive adhesive layer of the pressure sensitive adhesive sheet produced in each of Examples and Comparative Examples, the straightforward transmittance (%) of light rays having a wavelength of 550 nm was measured in the same manner as above. The pressure sensitive adhesive sheets produced in Examples and Comparative Examples other than Comparative Example 1 were irradiated with active energy rays under the same condition as in Testing Example 1 to cure the active energy ray curable pressure sensitive adhesives, and then the above measurement was performed. The results are listed in Table 4.

### <Testing Example 6> (Measurement of Adhesive Strength)

The second easy release sheet or the easy release sheet was removed from the pressure sensitive adhesive sheet prepared in each of Production Examples, and the exposed pressure sensitive adhesive layer was bonded to the easy-adhesion layer of a polyethylene terephthalate (PET) film having the easy-adhesion layer (available from TOYOBO CO., LTD., product name “PET A4300,” thickness: 100 μm) to obtain a laminate of release sheet/pressure sensitive adhesive layer/PET film. The obtained laminate was cut into a width of 25 mm and a length of 100 mm, and this was used as a sample.

The release sheet was removed from the above sample under an environment of 23° C. and 50% RH, and the exposed pressure sensitive adhesive layer was bonded to soda-lime glass (available from Nippon Sheet Glass Company, Ltd.) and then pressurized in an autoclave available from KURIHARA SEISAKUSHO Co., Ltd. at 0.5 MPa and 50° C. for 20 minutes. After that, the sample was left untouched under a condition of 23° C. and 50% RH for 24 hours, and the adhesive strength (before UV; N/25 mm) was then measured under a condition of a peel speed of 300 mm/min and a peel angle of 180° using a tensile tester (available from ORIENTEC Co., LTD., product name “TENSILON”). The measurement was conducted according to JIS 20237: 2009 except for the condition described herein. The results are listed in Table 3.

In addition, for the pressure sensitive adhesive sheet prepared in each of Production Examples 1, 2, and 4, the pressure sensitive adhesive layer was bonded to soda lime glass in the same manner as described above, autoclaved, and then left untouched under a condition of 23° C. and 50% RH for 24 hours. After that, the pressure sensitive adhesive sheet was irradiated with active energy rays through the PET film under the same condition as in Testing Example 1 to cure the pressure sensitive adhesive layer. For the cured pressure sensitive adhesive layer, the adhesive strength (after UV; N/25 mm) was measured in the same manner as described above. The results are listed in Table 3.

### <Testing Example 7> (Measurement of Step Following Ratio)

An ultraviolet curable ink (available from Teikoku Printing Inks Mfg. Co., Ltd., product name “POS-911 Black”) was screen-printed to have a frame-like shape (outer shape: length 90 mmxbreadth 50 mm, width 5 mm) on the surface of a glass plate (available from NSG Precision, product name “Corning Glass Eagle XG,” length 90 mmxbreadth 50 mm×thickness 0.5 mm). Then, the above printed ultraviolet curable ink was cured by being irradiated with ultraviolet rays (80 W/cm², two metal halide lamps, lamp height 15 cm, belt speed 10 to 15 m/min), and a stepped glass plate having steps due to printing (height of steps: any one of 5 μm, 10 μm, 15 μm, 20 μm, 25 μm, 30 μm, 45 μm, 60 μm, and 75 μm) was prepared.

The second easy release sheet or the easy release sheet was removed from the pressure sensitive adhesive sheet prepared in each of Production Examples, and the exposed pressure sensitive adhesive layer was bonded to the easy-adhesion layer of a polyethylene terephthalate (PET) film having the easy-adhesion layer (available from TOYOBO CO., LTD., product name “PET A4300,” thickness: 100 μm). Subsequently, the first easy release sheet or the tight release sheet was removed to expose the pressure sensitive adhesive layer. Then, using a laminator (available from HISAGO Co., Ltd./Fujipla, product name “LPD3214”), the above laminate was laminated to each stepped glass plate so that the pressure sensitive adhesive layer covered the entire surface of the frame-like printing, and this was used as a sample for evaluation.

The obtained sample for evaluation was autoclaved under a condition of 50° C. and 0.5 MPa for 30 minutes and then left untouched at normal pressure, 23° C., and 50% RH for 24 hours. The pressure sensitive adhesive sheets prepared in Production Examples 1, 2, and 4 were each irradiated with active energy rays under the same condition as in Testing Example 1 through the PET film to cure the pressure sensitive adhesive layer.

Subsequently, the sample was stored for 72 hours under a high-temperature and high-humidity condition of 85° C. and 85% RH (durability test), and then the step followability was evaluated. The step followability was determined as to whether or not the steps due to printing were completely filled with the pressure sensitive adhesive layer. When air bubbles, floating, delamination, etc. are observed at the interfaces between the steps due to printing and the pressure sensitive adhesive layer, a determination is made that the pressure sensitive adhesive layer cannot follow the irregularities of the steps due to printing. Here, the step followability was evaluated as the step following ratio (%) represented by the following equation. The results are listed in Table 4.

Step following ratio (%)={(Height (μm) of steps maintaining embedded state without air bubbles, floating, delamination, etc. after durability test)/(Thickness of pressure sensitive adhesive layer)}×100

### <Testing Example 8> (Evaluation of Uneven Optical Function)

A stepped glass plate prepared in the same manner as in Testing Example 7 and having steps due to printing (height of steps: 25 μm) and a glass plate without steps (available from NSG Precision, product name “Corning Glass Eagle XG,” length 90 mmxbreadth 50 mm×thickness 0.5 mm) were prepared as adherends. In Table 4, the stepped glass plates are listed as irregular plates, and the glass plates without steps are listed as smooth plates. In Table 4, the adherends to be bonded first are listed as first adherends while the adherends to be bonded later are listed as second adherends.

The second easy release sheet or the easy release sheet was removed from the pressure sensitive adhesive sheet produced in each of Examples and Comparative Examples, and the first layer of the exposed composite pressure sensitive adhesive layer was bonded to the first adherend. Then, the first easy release sheet or tight release sheet was removed from the composite pressure sensitive adhesive layer, and the second layer of the exposed composite pressure sensitive adhesive layer and the second adherend were bonded together.

The structure thus obtained was placed with the second adherend side down on a tablet terminal (available from Apple Inc., product name “iPad (registered trademark),” resolution: 264 ppi). For this sample, the tablet terminal was set to an entirely white display to visually observe the vicinity of steps. Then, the presence or absence of uneven optical function (coloring or light diffusion) was evaluated according to the following criteria. The results are listed in Table 4.
o: No uneven optical function was observed on the entire screen or in the vicinity of steps.
x: Uneven optical function was observed in the vicinity of steps.

As a reference, the pressure sensitive adhesive sheet produced in each of Examples and Comparative Examples was used to evaluate the uneven optical function in the same manner as above when the above two smooth plates were bonded together. As a result, no uneven optical function occurred in any of the pressure sensitive adhesive sheets.

### <Testing Example 9> (Evaluation of Development of Optical Function)

The structure obtained in the same manner as in Testing Example 8 was placed with the second adherend side down on the tablet terminal (available from Apple Inc., product name “iPad (registered trademark),” resolution: 264 ppi), and this was used as a sample. For the samples of Examples 1 to 3, 5, and 6 and Comparative Examples 2 and 3, the entire screen and the vicinity of steps were visually observed with the screen of the tablet terminal turned off. Then, the concealability was evaluated according to the following criteria.
o: It was difficult to see the boundaries between the steps due to printing and the display unit.
x: The boundaries between the steps due to printing and the display unit were clearly observed.

In addition, for the samples of Example 4 and Comparative Example 1, the tablet terminal was set to an entirely white display to visually observe the entire screen. Then, the presence or absence of uneven brightness was evaluated according to the following criteria.
o: There was no uneven brightness on the entire screen.
x: Uneven brightness was observed.

In the above evaluation, when the evaluation of “0” was obtained, a determination was made that development of the optical function was “present,” while when the evaluation of “x” was obtained, a determination was made that development of the optical function was “absent.”

TABLE 1

| | | | | | | | | | | | | Light- |
|---|---|---|---|---|---|---|---|---|---|---|---|---|
| | | | | | | | | | | | | diffusing |
| | | | | | | | | | | Cross- | Color- | fine |
| | | (Meth)acrylic ester polymer (A) | | | | | | | | linker | ant | particles |
| | | 2EHA | BA | MMA | IBXA | ACMO | HEA | AA | Mw | (B) | (C) | (D) |
| Production | Optically functional | 45 | 20 | — | 10 | 5 | 20 | — | 600k | 0.2 | 0.6 | — |
| Example 1 | pressure sensitive | | | | | | | | | | | |
| | adhesive layer (a) | | | | | | | | | | | |
| Production | Optically functional | 45 | 20 | — | 10 | 5 | 20 | — | 600k | 0.3 | — | 5 |
| Example 2 | pressure sensitive | | | | | | | | | | | |
| | adhesive layer (b) | | | | | | | | | | | |
| Production | Transparent pressure | 45 | 20 | — | 10 | 5 | 20 | — | 600k | 0.2 | — | — |
| Example 3 | sensitive adhesive | | | | | | | | | | | |
| | layer (c) | | | | | | | | | | | |
| Production | Transparent pressure | 45 | 20 | — | 10 | 5 | 20 | — | 600k | 0.2 | — | — |
| Example 4 | sensitive adhesive | | | | | | | | | | | |
| | layer (d) | | | | | | | | | | | |
| Production | Transparent pressure | 60 | 5 | 20 | — | — | 10 | 5 | 600k | 0.2 | — | — |
| Example 5 | sensitive adhesive | | | | | | | | | | | |
| | layer (e) | | | | | | | | | | | |

| | | | | | | Thickness of |
|---|---|---|---|---|---|---|
| | | Active | | | | pressure |
| | | energy ray | Photopoly- | Silane | Ultra- | sensitive |
| | | curable | merization | coupling | violet | adhesive |
| | | component (E) | Initiator (F) | agent | absorber | layer (μm) |
| Production | Optically functional | 5 | 0.5 | 0.3 | — | 50 |
| Example 1 | pressure sensitive | | | | | |
| | adhesive layer (a) | | | | | |
| Production | Optically functional | 5 | 0.5 | 0.3 | — | 50 |
| Example 2 | pressure sensitive | | | | | |
| | adhesive layer (b) | | | | | |
| Production | Transparent pressure | — | — | 0.3 | — | 50 |
| Example 3 | sensitive adhesive | | | | | |
| | layer (c) | | | | | |
| Production | Transparent pressure | 5 | 0.5 | 0.3 | — | 150 |
| Example 4 | sensitive adhesive | | | | | |
| | layer (d) | | | | | |
| Production | Transparent pressure | — | — | — | 4.5 | 50 |
| Example 5 | sensitive adhesive | | | | | |
| | layer (e) | | | | | |

TABLE 2

| | 380 | | Difference | | Standard |
|---|---|---|---|---|---|
| Type of | nm haze | 780 nm haze | between haze | Average | deviation of |
| colorant | value (%) | value (%) | values (points) | haze (%) | haze values |
| C1 | 10.1 | 2.3 | 7.8 | 4.11 | 1.49 |

TABLE 3

| | | | | Storage elastic | | Total | | Straightforward | Adhesive strength | | |
|---|---|---|---|---|---|---|---|---|---|---|---|
| | | Gel fraction (%) | | modulus (Mpa) | | luminous | Haze | transmittance | (N/25 mm) | | Step |
| | | Before | After | Before | After | transmittance | value | at | Before | After | following |
| | | UV | UV | UV | UV | (%) | (%) | 550 nm (%) | UV | UV | ratio (%) |
| Production | Optically functional | 52 | 72 | 0.06 | 0.14 | 49.2 | 2.9 | 40.0 | 42 | 44 | 40 |
| Example 1 | pressure sensitive | | | | | | | | | | |
| | adhesive layer (a) | | | | | | | | | | |
| Production | Optically functional | 54 | 69 | 0.08 | 0.15 | ≥99 | 92.2 | 40.3 | 44 | 45 | 30 |
| Example 2 | pressure sensitive | | | | | | | | | | |
| | adhesive layer (b) | | | | | | | | | | |
| Production | Transparent | 56 | — | 0.08 | — | ≥99 | 0.2 | 99.4 | 43 | — | 40 |
| Example 3 | pressure sensitive | | | | | | | | | | |
| | adhesive layer (c) | | | | | | | | | | |
| Production | Transparent | 54 | 71 | 0.06 | 0.15 | ≥99 | 0.2 | 99.4 | 51 | 55 | 40 |
| Example 4 | pressure sensitive | | | | | | | | | | |
| | adhesive layer (d) | | | | | | | | | | |
| Production | Transparent | 61 | — | 0.10 | — | ≥99 | 0.4 | 99.3 | 22 | — | 20 |
| Example 5 | pressure sensitive | | | | | | | | | | |
| | adhesive layer (e) | | | | | | | | | | |

TABLE 4

| | | | Total | | Straightfor- | | | | | |
|---|---|---|---|---|---|---|---|---|---|---|
| | | | luminous | | ward trans- | Evaluation of uneven optical function | | | | Develop- |
| | Configuration of composite pressure sensitive | | transmit- | Haze | mittance | | | Evalu- | Smooth | ment of |
| | adhesive layer | | tance | value | at 550 | First | Second | ation | plates | optical |
| | First layer | Second layer | (%) | (%) | nm (%) | adherend | adherend | result | together | function |
| Example 1 | Optically functional | Transparent pressure | 49.1 | 4.6 | 40.1 | Irregular | Smooth | ∘ | ∘ | Present |
| | pressure sensitive | sensitive adhesive | | | | plate | plate | | | |
| | adhesive layer (a) | layer (c) | | | | | | | | |
| Example 2 | Optically functional | Transparent pressure | 49.1 | 4.6 | 40.1 | Smooth | Irregular | ∘ | ∘ | Present |
| | pressure sensitive | sensitive adhesive | | | | plate | plate | | | |
| | adhesive layer (a) | layer (c) | | | | | | | | |
| Example 3 | Optically functional | Transparent pressure | 49.1 | 4.6 | 40.1 | Smooth | Irregular | ∘ | ∘ | Present |
| | pressure sensitive | sensitive adhesive | | | | plate | plate | | | |
| | adhesive layer (a) | layer (d) | | | | | | | | |
| Example 4 | Optically functional | Transparent pressure | ≥99 | 92.3 | 40.2 | Irregular | Smooth | ∘ | ∘ | Present |
| | pressure sensitive | sensitive adhesive | | | | plate | plate | | | |
| | adhesive layer (b) | layer (c) | | | | | | | | |
| Example 5 | Optically functional | Transparent pressure | 48.8 | 4.6 | 39.8 | Smooth | Irregular | ∘ | ∘ | Present |
| | pressure sensitive | sensitive adhesive | | | | plate | plate | | | |
| | adhesive layer (a) | layer (e) | | | | | | | | |
| Example 6 | Optically functional | Transparent pressure | 48.8 | 4.6 | 39.8 | Irregular | Smooth | ∘ | ∘ | Present |
| | pressure sensitive | sensitive adhesive | | | | plate | plate | | | |
| | adhesive layer (a) | layer (e) | | | | | | | | |
| Comparative | Transparent pressure | Transparent pressure | ≥99 | 0.2 | 98.8 | Irregular | Smooth | ∘ | ∘ | Absent |
| Example 1 | sensitive adhesive | sensitive adhesive | | | | plate | plate | | | |
| | layer (c) | layer (c) | | | | | | | | |
| Comparative | Transparent pressure | Optically functional | 49.1 | 4.8 | 39.9 | Smooth | Irregular | x | ∘ | Present |
| Example 2 | sensitive adhesive | pressure sensitive | | | | plate | plate | | | |
| | layer (c) | adhesive layer (a) | | | | | | | | |
| Comparative | Transparent pressure | Optically functional | 49.1 | 4.8 | 39.9 | Irregular | Smooth | x | ∘ | Present |
| Example 3 | sensitive adhesive | pressure sensitive | | | | plate | plate | | | |
| | layer (c) | adhesive layer (a) | | | | | | | | |

As found from Table 4, the pressure sensitive adhesive sheet obtained in each of Examples developed the optical function and suppressed the uneven optical function. Moreover, as found from Table 3, the pressure sensitive adhesive sheet obtained in each of Examples was excellent also in the step followability under high-temperature and high-pressure conditions.

### INDUSTRIAL APPLICABILITY

The pressure sensitive adhesive sheet according to the present invention can be suitably used for bonding or the like of a display body structural member having irregularities and a desired display body structural member, for example, in a display body required to have uniform coloring or light diffusion.

### DESCRIPTION OF REFERENCE NUMERALS

1 Pressure sensitive adhesive sheet
11 Composite pressure sensitive adhesive layer
111 Transparent pressure sensitive adhesive layer
112 Optically functional pressure sensitive
adhesive layer
12a First release sheet (easy release sheet)
12b Second release sheet (tight release sheet)
2A, 2B Structure
21 First display body structural member
22 Second display body structural member
23 Printed layer

1. A pressure sensitive adhesive sheet for bonding two rigid plates together,
at least one of the two rigid plates having irregularities on a surface on a side to be bonded to the other rigid plate,
the pressure sensitive adhesive sheet comprising:
a composite pressure sensitive adhesive layer comprising an optically functional pressure sensitive adhesive layer and a transparent pressure sensitive adhesive layer that does not have an optical function of the optically functional pressure sensitive adhesive layer; and
a release sheet laminated on the transparent pressure sensitive adhesive layer in the composite pressure sensitive adhesive layer,
the composite pressure sensitive adhesive layer having a straightforward transmittance of 90% or less for light rays having a wavelength of 550 nm.

2. The pressure sensitive adhesive sheet according to claim 1, wherein when the optical function of the optically functional pressure sensitive adhesive layer is coloring, the composite pressure sensitive adhesive layer has a haze value of 0.1% or more and 30% or less.

3. The pressure sensitive adhesive sheet according to claim 1, wherein when the optical function of the optically functional pressure sensitive adhesive layer is light diffusion, the composite pressure sensitive adhesive layer has a haze value of 70% or more and 100% or less.

4. The pressure sensitive adhesive sheet according to claim 1, wherein when the optical function of the optically functional pressure sensitive adhesive layer is coloring, the composite pressure sensitive adhesive layer has a total luminous transmittance of 5% or more and 90% or less.

5. The pressure sensitive adhesive sheet according to claim 1, wherein when the optical function of the optically functional pressure sensitive adhesive layer is light diffusion, the composite pressure sensitive adhesive layer has a total luminous transmittance of 70% or more and 100% or less.

6. The pressure sensitive adhesive sheet according to claim 1, wherein a pressure sensitive adhesive that constitutes the optically functional pressure sensitive adhesive layer is an acrylic-based pressure sensitive adhesive.

7. The pressure sensitive adhesive sheet according to claim 1, wherein a pressure sensitive adhesive that constitutes the transparent pressure sensitive adhesive layer is an acrylic-based pressure sensitive adhesive.

8. The pressure sensitive adhesive sheet according to claim 1, wherein
the release sheet laminated on the transparent pressure sensitive adhesive layer in the composite pressure sensitive adhesive layer is a tight release sheet, and
an easy release sheet is laminated on the optically functional pressure sensitive adhesive layer in the composite pressure sensitive adhesive layer.

9. A method for manufacturing a structure obtained by bonding two rigid plates together, at least one of the two rigid plates having irregularities on a surface on a side to be bonded to the other rigid plate, the method comprising:
bonding an optically functional pressure sensitive adhesive layer of a composite pressure sensitive adhesive layer to one of the two rigid plates, the composite pressure sensitive adhesive layer comprising the optically functional pressure sensitive adhesive layer and a transparent pressure sensitive adhesive layer that does not have an optical function of the optically functional pressure sensitive adhesive layer, the composite pressure sensitive adhesive layer having a straightforward transmittance of 90% or less for light rays having a wavelength of 550 nm; and
then bonding the transparent pressure sensitive adhesive layer of the composite pressure sensitive adhesive layer and the other of the two rigid plates.

10. The method for manufacturing the structure according to claim 9, wherein both the two rigid plates are display body structural members.
